(19) United States
(12) Patent Application Publication
(10) Pub. No.: US 2026/0158428 A1
(43) Pub. Date: Jun. 11, 2026

(54) METHODS OF MAKING FILTRATION ARTICLES HAVING FILTRATION MATERIAL DEPOSITS

(71) Applicant: CORNING INCORPORATED, CORNING, NY (US)

(72) Inventors: William Peter Addiego, Big Flats, NY (US); Sophie Anlan Chen, Painted Post, NY (US); Curtis Robert Fekety, Corning, NY (US); Insik Jeon, Novi, MI (US); He Jing, Clayton, MO (US); Jia Liu, Painted Post, NY (US)

(21) Appl. No.: 19/124,525

(22) PCT Filed: Nov. 3, 2023
(86) PCT No.: PCT/US2023/036774

§ 371 Date: Apr. 25, 2025

Related U.S. Application Data
(60) Provisional application No. 63/426,514, filed on Nov. 18, 2022.

(51) Int. Cl. B01D 46/24

(52) U.S. Cl. CPC B01D 46/2418; B01D 2201/62; B01D 2239/0471

(57) ABSTRACT

Methods for applying a surface treatment to a plugged honeycomb body include atomizing a dispersion of particles of an inorganic material into liquid-particulate-dispersant droplets comprised of: a liquid vehicles that are one or more solvents other than ethanol, or mixtures of water and solvents, and one or more dispersants. In some embodiments, the liquid vehicle comprises methanol, acetone, hexane, or combinations thereof; a particle dispersant comprises: triethanolamine, triethoxyvinylsilane, vinyltrimethoxysilane, 5-hexanyltrimethoxysaline, or combinations thereof. In some embodiments, the liquid vehicle comprises water and a solvent selected from the group consisting of: ethanol, methanol, acetone, hexane, or combinations thereof.

### CROSS REFERENCE TO RELATED APPLICATION

This application claims the benefit of priority under 35 U.S.C. § 119 of U.S. Provisional Application Ser. No. 63/426,514, filed on Nov. 18, 2022, the content of which is relied upon and incorporated herein by reference in its entirety.

### BACKGROUND

### Field

The present specification relates to methods of making porous bodies, such as porous ceramic honeycomb bodies, suitable for filtration articles, which comprise filtration material deposits, including inorganic deposits, which are comprised of agglomerates. Methods utilize mixture preparations that include liquid vehicles, which are one or more solvents other than ethanol, or mixtures of water and solvents, and dispersants.

### Technical Background

Wall-flow filters are employed to remove particulates from fluid exhaust streams, such as from combustion engine exhaust. Examples include diesel particulate filters used to remove particulates from diesel engine exhaust gases and gasoline particulate filters (GPF) used to remove particulates from gasoline engine exhaust gases. Exhaust gas to be filtered enters inlet cells and passes through the cell walls to exit the filter via outlet channels, with the particulates being trapped on or within inlet cell walls as the gas traverses and then exits the filter.

As vehicle exhaust regulation is getting stricter worldwide, there is a continuing need to improve GPF filtration performance with respect to filtration efficiency and pressure drop penalty. There is also a continuing need to utilize raw materials efficiently and improve process throughput.

### SUMMARY

Aspects of the disclosure pertain to filtration articles and methods for their manufacture and use.

In an aspect, methods for applying a surface treatment to a plugged honeycomb body comprising a honeycomb structure of a plurality of axial porous walls defining a plurality of axial channels in an axial direction comprise: atomizing a dispersion of particles of an inorganic material into liquid-particulate-dispersant droplets comprised of: a liquid vehicle comprising methanol, acetone, hexane, or combinations thereof; a particle dispersant comprising: triethanolamine, triethoxyvinylsilane, vinyltrimethoxysilane, 5-hexanyltrimethoxysaline, or combinations thereof, and the particles; evaporating substantially all of at least the liquid vehicle from the droplets to form agglomerates of the particles; and depositing the agglomerates within the plugged honeycomb body; wherein the deposited agglomerates are disposed on, or in, or both on and in, the porous walls.

Another aspect provides methods for applying a surface treatment to a plugged honeycomb body comprising a honeycomb structure of a plurality of axial porous walls defining a plurality of axial channels in an axial direction comprise: atomizing a dispersion of particles of an inorganic material into liquid-particulate-dispersant-binder droplets consisting essentially of: a liquid vehicle comprising methanol, acetone, hexane, or combinations thereof, a particle dispersant, a binder, and the particles; evaporating substantially all of at least the liquid vehicle from the droplets to form agglomerates of the particles; and depositing the agglomerates within the plugged honeycomb body; wherein the deposited agglomerates are disposed on, or in, or both on and in, the porous walls.

In another aspect, methods for applying a surface treatment to a plugged honeycomb body comprising a honeycomb structure of a plurality of axial porous walls defining a plurality of axial channels in an axial direction comprise: atomizing a dispersion of particles of an inorganic material into liquid-particulate-dispersant droplets comprised of: a liquid vehicle comprising water and one or more solvents having a lower boiling point than the water, a particle dispersant, and the particles; evaporating substantially all of at least the liquid vehicle from the droplets to form agglomerates of the particles; and depositing the agglomerates within the plugged honeycomb body; wherein the deposited agglomerates are disposed on, or in, or both on and in, the porous walls.

An aspect is a filtration article prepared according to any method herein comprising a filtration efficiency of greater than or equal to 95.0% and a loading of the deposited agglomerates of less than or equal to 6 grams of the deposited agglomerates per liter of the honeycomb filter body.

Additional features and advantages will be set forth in the detailed description, which follows, and in part will be readily apparent to those skilled in the art from that description or recognized by practicing the embodiments described herein, comprising the detailed description, which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a flowchart depicting an exemplary embodiment of a process of forming filtration material according to embodiments herein;

FIG. 2 schematically depicts an apparatus for depositing filtration material, including inorganic material, according to embodiments herein;

FIG. 3 schematically depicts an apparatus for depositing filtration material, including inorganic material according to embodiments herein;

FIG. 4 schematically depicts an apparatus for depositing filtration material, including inorganic material according to embodiments herein;

FIG. 5 schematically depicts an apparatus for depositing filtration material, including inorganic material according to embodiments herein;

FIG. 6 schematically depicts an apparatus for depositing filtration material, including inorganic material according to embodiments herein;

FIG. 7 schematically depicts an unplugged honeycomb body;

FIG. 8 schematically depicts a wall-flow particulate filter according to embodiments disclosed and described herein;

FIG. 9 is a cross-sectional longitudinal view of the particulate filter shown in FIG. 12;

FIG. 10 schematically depicts a wall of a honeycomb body with particulate loading;

FIG. 11 schematically depicts a 2D coating apparatus for depositing filtration material, including inorganic material according to embodiments herein;

FIGS. 12-14 provide SEM photographs showing samples prepared according to Example A and Examples 1-2; and

FIGS. 15-16 provide SEM photographs showing samples prepared according to Example B and Example 3.

### DETAILED DESCRIPTION

Reference will now be made in detail to embodiments of filtration articles and methods for forming honeycomb bodies comprising a porous honeycomb body comprising filtration material deposits on, or in, or both on and in, the porous ceramic walls of the honeycomb body matrix, embodiments of which are illustrated in the accompanying drawings. Deposits comprise material that was deposited into the honeycomb body, as well as compounds that may be formed, for example, by heating, from one or materials that were originally deposited. For example, a binder may be transformed by heating into an organic component which is eventually burned off or volatilized, while an inorganic component (such as silica) remains contained within the honeycomb filter body. Whenever possible, the same reference numerals will be used throughout the drawings to refer to the same or like parts.

### Definitions

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to”.

A “honeycomb body,” as referred to herein, comprises a ceramic honeycomb structure of a matrix of intersecting walls that form cells which define channels. The ceramic honeycomb structure can be formed, extruded, or molded from a plasticized ceramic or ceramic-forming batch mixture or paste. A honeycomb body may comprise an outer peripheral wall, or skin, which was either extruded along with the matrix of walls or applied after the extrusion of the matrix. For example, a honeycomb body can be a plugged ceramic honeycomb structure which forms a filter body comprised of cordierite or other suitable ceramic material. A plugged honeycomb body has one or more channels plugged at one, or both ends of the body.

### Filtration Articles

A honeycomb filter body disclosed herein comprises a ceramic honeycomb structure comprising at least one wall carrying one or more filtration material deposits which is configured to filter particulate matter from a gas stream. The filtration material deposits can be in discrete regions or in some portions or some embodiments can form one or more layers of filtration material at a given location on the wall of the honeycomb body. The filtration material deposits according to some embodiments comprise inorganic material, in some embodiments organic material, and in some embodiments both inorganic material and organic material. For example, a honeycomb body may, in one or more embodiments, be formed from cordierite or other porous ceramic material and further comprise filtration material deposits, including inorganic material deposits, disposed on or below wall surfaces of the cordierite honeycomb structure.

In some embodiments, the filtration material deposits, including inorganic deposits comprises one or more of ceramic or refractory materials. In some embodiments, the filtration material deposits comprise an inorganic material to yield inorganic deposits. In some embodiments, the filtration material deposits, including inorganic deposits comprise alumina particles, including alumina nanoparticles, which may agglomerate and/or aggregate.

Filtration articles herein include advantageous surface layer microstructures effective to improve filtration efficiency (FE) with minimal impact on pressure drop, including being effective to meet ultra-high FE requirements in accordance with Euro 7 regulations. Methods herein utilize mixture preparations that include liquid vehicles, which are one or more solvents other than ethanol, or mixtures of water and solvents, and one or more dispersants. In one or more embodiments, a particle dispersant is selected based on a composition of the liquid vehicle. In one or more embodiments, the mixture preparations exclude adhesion promoters. In one or more embodiments, the mixture preparations consist essentially or consist of: a liquid vehicle that is a non-ethanol solvent or is a mixture of water and an organic solvent; a particle dispersant, particles, an optionally a binder. In one or more embodiments, the mixture preparations consist essentially or consist of: a liquid vehicle comprising methanol, acetone, hexane, or combinations thereof, a particle dispersant, and particles. In one or more embodiments, the mixture preparations consist essentially or consist of: a liquid vehicle comprising methanol, acetone, hexane, or combinations thereof, a particle dispersant, a binder, and particles.

The mixture preparations herein facilitate a reduction in coating loading requirement to prepare the filtration articles, which in turn provides advantages of: (1) reducing raw material usage, (2) speeding up manufacturing time.

Relative to methods that utilize liquid vehicles of ethanol alone when atomizing a dispersion of particles of an inorganic material into droplets, smaller spray droplets and resulting agglomerates are formed by using one or more non-ethanol organic solvents with lower surface tension or viscosity and/or lower boiling point relative to ethanol. Without intending to be bound by theory, sprayed droplet sizes are smaller due to the lower surface tension, and use of a solvent with lower boiling point, leads to faster evaporation of the droplets, which impedes the particle agglomeration and growth. Smaller agglomerate size leads to lower loading requirements to reach a desired filtration efficiency (FE). In one or more embodiments, agglomerates generated using one or more non-ethanol organic solvents with lower surface tension or viscosity and/or lower boiling point relative to ethanol comprise a volume-based average particle diameter (D₅₀) that is smaller than that of agglomerates generated using ethanol only, for a given set of operating conditions otherwise. In one or more embodiments, agglomerates generated using one or more non-ethanol organic solvents with lower surface tension or viscosity and/or lower boiling point relative to ethanol comprise a median particle size (D₅₀) that is smaller than that of agglomerates generated using ethanol only, for a given set of operating conditions otherwise. In one or more embodiments, agglomerates comprise a volume-based average particle diameter (D₅₀) in a range of greater than or equal to 0.5 micrometers to less than or equal to 0.95 micrometers, including all values and subranges therebetween. Agglomerates generated by ethanol only for a given set of operating conditions are considered comparative agglomerates having a comparative a volume-based average particle diameter (D₅₀) or a comparative volume-based average particle diameter (D₅₀).

Similarly, relative to methods that utilize liquid vehicles of water alone when atomizing a dispersion of particles of an inorganic material into droplets, smaller spray droplets and resulting agglomerates are formed by mixing water with one or more organic solvents with lower surface tension or viscosity and/or lower boiling point relative to water. In one or more embodiments, agglomerates generated using a mixture of water with one or more organic solvents with lower surface tension or viscosity and/or lower boiling point relative to water comprise a volume-based average particle diameter (D₅₀) that is smaller than that of agglomerates generated using water only, for a given set of operating conditions otherwise. In one or more embodiments, agglomerates generated using a mixture of water with one or more organic solvents with lower surface tension or viscosity and/or lower boiling point relative to water comprise a volume-based average particle diameter (D₅₀) that is smaller than that of agglomerates generated using water only, for a given set of operating conditions otherwise. In one or more embodiments, in a range of greater than or equal to 0.5 micrometers to less than or equal to 0.97 micrometers, including all values and subranges therebetween. Agglomerates generated by water only for a given set of operating conditions are considered comparative agglomerates having a comparative a volume-based average particle diameter (D₅₀) or a comparative volume-based average particle diameter (D₅₀).

### Methods

Aspects of the disclosure pertain to methods of forming porous bodies, such as porous ceramic honeycomb bodies, comprising a material such as a filtration material such as an inorganic material such as a ceramic or refractory material or even a porous ceramic or refractory material. In specific embodiments, the filtration material is an aerosol-deposited filtration material. In some preferred embodiments, the filtration material comprises a plurality of inorganic particle agglomerates, wherein the agglomerates are comprised of inorganic, such as ceramic or refractory, material. In some embodiments, the agglomerates are porous, which may allow gas to flow through the agglomerates.

Aerosol deposition enables deposition of filtration material onto the porous ceramic walls, which can be discrete regions as small as a single agglomerate or larger such as a plurality of agglomerates, and in some embodiments is in the form of a porous layer of filtration material, on or in, or both on and in, at least some surfaces of the walls of the ceramic honeycomb body. In certain embodiments, an advantage of the aerosol deposition method according to one or more embodiments is that ceramic honeycomb bodies with enhanced filtration performance can be produced economically, and/or more efficiently.

In certain embodiments, an aerosol deposition process disclosed herein comprises: mixture preparation (e.g., particles of inorganic material, liquid vehicle, and a binder), atomizing the mixture with an atomizing gas with a nozzle to form agglomerates and/or aggregates, comprised of the inorganic material, the liquid vehicle, and the binder, drying the agglomerates and/or aggregates in the presence of a carrier gas or a gaseous carrier stream, depositing the aggregates and/or agglomerates onto the honeycomb bodies, and optionally curing the material. In some embodiments, walls of the apparatus can be heated to assist in drying the aggregates and/or agglomerates.

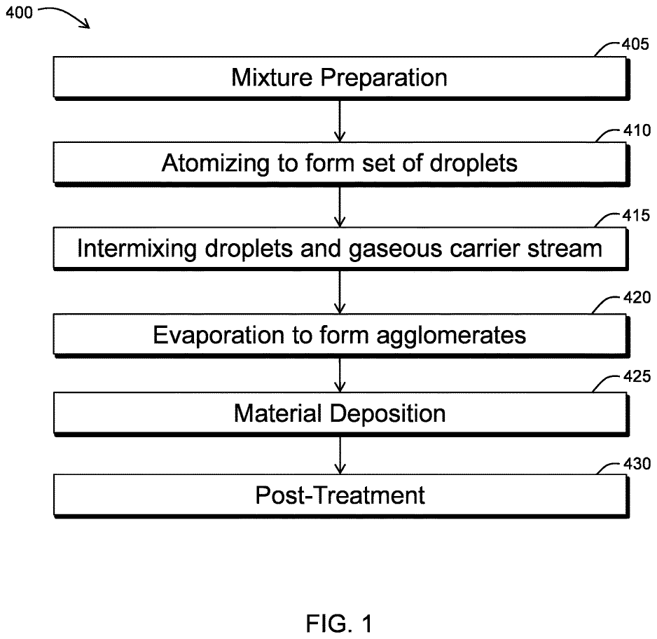

According to one or more embodiments, as shown in FIG. 1, a process 400 comprises operations of: mixture preparation 405, atomizing to form droplets 410, intermixing droplets and a gaseous carrier stream 415; evaporating liquid vehicle to form agglomerates 420, depositing of material, e.g., agglomerates, on the walls of a wall-flow filter 425, and optional post-treatment 430 to, for example, bind the material on, or in, or both on and in, the porous walls of the honeycomb body.

In the process of FIG. 1, the aerosol deposition forms filtration material deposits, including inorganic material deposits, which in some specific embodiments are porous material deposits. In some embodiments, the material deposits are in the form of discrete regions of filtration material. In some embodiments, at least some portions of the material deposits may be in the form of a porous inorganic layer.

In various embodiments, the process further includes part-switching such that depositing of agglomerates onto the porous walls of a plugged honeycomb body is conducted semi-continuously or continuously, which reduces idle time of the equipment. In one or more embodiments, the part-switching is timed so that deposition is essentially continuous into and/or onto a plurality of ceramic honeycomb bodies. Reference to continuous means that the operating equipment is maintained under operating temperatures and pressures and raw material supply flow, and that the flow of the gaseous carrier stream and agglomerates into a part such as a wall-flow filter is interrupted only to switch out a loaded part for an unloaded part. Semi-continuous allows also for minor interruptions to the raw material supply flow and adjustments to operating temperatures and pressures. In one or more embodiments, semi-continuous flow means that flow is interrupted for greater than or equal to 0.1% to less than or equal to 5% of an operating duration, including greater than or equal to 0.5%, greater than or equal to 1%, greater than or equal to 1.5%, greater than or equal to 2%, greater than or equal to 2.5%, and/or less than or equal to 4.5%, less than or equal to 4%, less than or equal to 3.5%, less than or equal to 3%. In one or more embodiments, flow is continuous for greater than or equal to 95% to less than or equal to 100% of an operating duration, including greater than or equal to 96%, greater than or equal to 97%, greater than or equal to 98%, greater than or equal to 99%, greater than or equal to 99.5%, and/or less than or equal to 99.9%, less than or equal to 99%, less than or equal to 98%, less than or equal to 97%.

### Mixture Preparation 405.

Commercially available inorganic particles can be used as a raw material in a mixture in the formation of an inorganic material for depositing. According to one or more embodiments, the particles are selected from Al₂O₃, SiO₂, TiO₂, CeO₂, ZrO₂, SiC, MgO and combinations thereof. In one or more embodiments, the mixture is a suspension. The particles may be supplied as a raw material suspended in a liquid vehicle.

LIQUID VEHICLE: one or more non-ethanol organic solvents. In some embodiments, the mixture preparation, including the suspension, is organic-based, comprising a liquid vehicle comprising one or more non-ethanol organic solvents. In one or more embodiments, the non-ethanol organic solvents comprise an organic solvent with lower surface tension or viscosity and/or lower boiling point relative to ethanol. In one or more embodiments, the liquid vehicle comprises methanol, acetone, hexane, or combinations thereof. In one or more embodiments, the liquid vehicle consists essentially of methanol, acetone, hexane, or combinations thereof. In one or more embodiments, the liquid vehicle consists of methanol, acetone, hexane, or combinations thereof.

LIQUID VEHICLE: mixing water with one or more organic solvents with lower surface tension or viscosity and/or lower boiling point relative to water. In some embodiments, the mixture preparation, including the suspension, comprises a liquid vehicle that is a mixture of water and one or more organic solvents with lower surface tension or viscosity and/or lower boiling point relative to water. In one or more embodiments, the liquid vehicle comprises: water, and one or more solvents selected from the group consisting of: ethanol, methanol, acetone, hexane, or combinations thereof. In one or more embodiments, the liquid vehicle consists essentially of: water, and one or more solvents selected from the group consisting of: ethanol, methanol, acetone, hexane, or combinations thereof. In one or more embodiments, the liquid vehicle consists of: water, and one or more solvents selected from the group consisting of: ethanol, methanol, acetone, hexane, or combinations thereof.

PARTICLE DISPERSANT. The particle dispersant may have one or both of the following properties: (1) ability to modify the surface charges on the particles, namely alumina particles, to minimize and/or avoid any agglomeration in the mixture preparation/suspension; and/or (2) possess two types of functional groups, with one group helping the dispersant attach to the particles, including alumina particles, and the other functional group facilitating the dispersant being miscible with the solvent. In one or more embodiments, the mixture preparation, including the suspension, further comprises a particle dispersant. In one or more embodiments, the particle dispersant comprises: triethanolamine, triethoxyvinylsilane, vinyltrimethoxysilane, 5-hexanyltrimethoxysaline, or combinations thereof. In one or more embodiments, when the liquid vehicle comprises the methanol, the particle dispersant comprises the triethanolamine. In one or more embodiments, when the liquid vehicle comprises the acetone, the particle dispersant comprises the triethoxyvinylsilane or the vinyltrimethoxysilane. In one or more embodiments, when the liquid vehicle comprises the hexane, the particle dispersant comprises the 5-hexanyltrimethoxysaline. In one or more embodiments, when the liquid vehicle comprises water and an organic solvent, the particle dispersant comprises acetic acid, triethanolamine, triethoxyvinylsilane, vinyltrimethoxysilane, and/or 5-hexanyltrimethoxysaline. In some embodiments, Troysperse W® by Troy Corporation, which is a surfactant and modified fatty acids, is a suitable particle dispersant.

ADHESION PROMOTERS. In one or more embodiments, the mixture preparations, including the suspension, exclude adhesion promoters. Reference to “adhesion promoter” is to an ingredient that exhibits one or more of epoxy reactivity and methoxysilyl inorganic reactivity. In one or more embodiments, the mixture preparations, including the suspension, excludes materials of the group consisting of: (γ-Glycidoxypropyl)trimethoxysilane, (3-Glycidoxybutyl)trimethoxysilane, (3-Glycidoxyethyl)trimethoxysilane, and 3-GlycidoxyHexadecyltrimethoxysilane.

In some embodiments, the suspension comprises by weight: 5-20% particles, 0.1 to 5% particle dispersant, and 80-95% liquid vehicle, and all values and subranges therebetween. In an embodiment, the suspension comprises by weight: 11 percent±1% alumina, 2 percent ±0.5% particle dispersant, and 87 percent±1% liquid vehicle.

In one or more embodiments, the particles have an average primary particle size in a range of from about 10 nm to about 4 microns, about 20 nm to about 3 microns or from about 50 nm to about 2 microns, or from about 50 nm to about 900 nm or from about 50 nm to about 600 nm. In specific embodiments, the average primary particle size is in a range of from about 100 nm to about 200 nm, for example, 150 nm. The average primary particle size can be determined as a calculated value from the Brunauer, Emmett and Teller (BET) surface area of the aerosol particles, which in some embodiments is greater than or equal to 7.0 m²/g to less than or equal to 30 m²/g, including all values and ranges therebetween, including 9 m²/g.

In one or more embodiments, the primary particles comprise a ceramic particle, such as an oxide particle, for example Al₂O₃, SiO₂, MgO, CeO₂, ZrO₂, CaO, TiO₂, cordierite, mullite, SiC, aluminum titanate, and mixtures thereof.

An additional amount of liquid (e.g., diluent) may be added to the mixture to dilute the suspension if needed. In one or more embodiments, the additional liquid is the same as the liquid vehicle. Decreasing the solids content in the mixture could reduce the aggregate size proportionally if the droplet generated by atomizing has similar size. The diluent should be miscible with suspension mentioned above, and may be effective to dissolve and/or disperse the binder and other ingredients.

BINDER. Binder may be optionally added to reinforce the agglomerates and to provide a stickiness or tackiness, and can comprise inorganic binder, to provide mechanical integrity to deposited material. In some specific embodiments, the binder can provide binding strength between particles at elevated temperature (>500° C.). The starting material can be organic. After exposure to high temperature in excess of about 150° C., the organic starting material will decompose or react with moisture and oxygen in the air, and the final deposited material composition could comprise Al₂O₃, SiO₂, MgO, CeO₂, ZrO₂, CaO, TiO₂, cordierite, mullite, SiC, aluminum titanate, and mixtures thereof.

In one or more embodiments, the binder is a silicon-containing compound. In one or more embodiments, the silicon-containing compound is comprised of a siloxane or polysiloxane, silicone, a silicate, or a combination thereof. In one or more embodiments, the silicon-containing compound is comprised of a silicone compound, polysiloxane, silicone resin, siloxane, alkoxysiloxane, or combinations thereof. In one or more embodiments, the silicon-containing compound is comprised of a silicate, an alkaline silicate, a sodium silicate, or combinations thereof.

Catalyst can be added to accelerate the cure reaction of binder. An exemplary catalyst content is 1% by weight of the binder.

Stirring of the mixture or suspension during storage and/or awaiting delivery to the nozzle may be conducted by using desired stirring techniques. In one or more embodiments, stirring is conducted by a mechanical stirrer. In an embodiment, the use of a mechanical stirrer facilitates reduction and/or elimination of potential contaminations from plastic-coated mixing rods, which are in contact with a holding vessel, used in magnetic stirring systems.

Atomizing to form droplets 410. The mixture is atomized into fine droplets by high pressure gas through a nozzle. This setup is comprised of a nozzle body along with fluid cap and air cap. The atomizing gas can contribute to breaking up the liquid-particulate-binder stream into the droplets.

In one or more embodiments, the nozzle herein is a nozzle that utilizes internal mixing. In one or more embodiments, the nozzle herein is a nozzle that utilizes external mixing. External mix nozzles can be advantageous to allow for smaller particle sizes with tighter particle size distribution which improves material utilization and filtration efficiency. External mix nozzles tend to clog less often as compared to internal mix nozzles. In one or more embodiments, the nozzles herein are converging nozzles. As used herein, converging nozzles refer to nozzles having fluid flow passages whose cross-sectional areas decrease from inlet to outlet thereby accelerating flow of the fluids. Converging nozzles may be internally mixed or externally mixed. In one or more embodiments, the liquid-particulate-binder droplets are directed into the chamber by a nozzle.

In one or more embodiments, the liquid-particulate-binder droplets are directed into the chamber by a plurality of nozzles. In one or more embodiments, atomizing the plurality of liquid-particulate-binder streams occurs with a plurality of atomizing nozzles. The plurality of nozzles may include 2 or more nozzles, 3 or more, 4 or more, 5 or more, 6 or more, 7 or more, 8 or more, 9 or more, 10 or more, and the like. The plurality of nozzles may be evenly spaced within the chamber. In one or more embodiments, each of the plurality of nozzles is angled toward a center of the apparatus. The angle of the nozzles may be acute, ranging from less than 900 to greater than 10° relative to a side wall of the apparatus, and all values and subranges therebetween, including 200 to 45°.

The pressure of the atomizing gas may be in the range of 20 psi to 230 psi. The pressure of the liquid may be in the range of 1 to 100 psi. The average droplet size according to one or more embodiments may be in the range of from 1 micron to 40 microns, including for example, in a range of greater than or equal to 1 micron to less than or equal to 15 microns; greater than or equal to 2 microns to less than or equal to 8 microns; greater than or equal to 4 microns to less than or equal to 8 microns; and greater than or equal to 4 microns to less than or equal to 6 microns; and all values and subranges therebetween. The droplet size can be adjusted by adjusting the surface tension of the mixture, viscosity of the mixture, density of the mixture, gas flow rate, gas pressure, liquid flow rate, liquid pressure, and nozzle design. In one or more embodiments, the atomizing gas comprises nitrogen. In one or more embodiments, the atomizing gas may consist essentially of an inert gas. In one or more embodiments, the atomizing gas may is predominantly one or more inert gases. In one or more embodiments, the atomizing gas may is predominantly nitrogen gas. In one or more embodiments, the atomizing gas may is predominantly air. In one or more embodiments, the atomizing gas may consist essentially of nitrogen or air. In one or more embodiments, the atomizing gas may be dry. In one or more embodiments, the atomizing gas may comprise essentially no liquid vehicle upon entry to the chamber.

In some embodiments, the suspension flow rate is in the range of 10 to 80 g/minute, including all values and subranges therebetween, including 18 g/min. In some embodiments, the atomizing gas flow rate nitrogen flow rate is in the range of 2 to 20 Nm³/hr, including all values and subranges therebetween, including 5-6 Nm³/hr.

Suspension flow and corresponding agglomerate size may be controlled by a pressure control system or a flow control system, as appropriate to the apparatus. For a pressure control system, a pressure controller is in communication with a delivery conduit such as tubing or piping and a suspension of primary particles in a liquid is introduced into the delivery conduit, which is then flowed to the nozzle. For a flow control system, an injector pump is provided, which delivers the suspension of primary particles in a liquid to the nozzle. Atomizing gas is typically separately supplied to the nozzle. In a preferred embodiment, a pump directs the liquid-particulate-binder mixture to the atomizing nozzle at a substantially constant flow rate. A constant flow rate can be advantageous as opposed to maintaining a constant pressure because the constant flow rate can help reduce variability in the particle sizes which, in turn, improves material utilization.

In one or more embodiments, the suspension comprises an inorganic material, a liquid vehicle, and a particle dispersant, which is supplied to the nozzle as a liquid-particulate-dispersant stream. That is, particles of an inorganic material can be mixed with a liquid vehicle and a particle dispersant to form a liquid-particulate-dispersant stream. The liquid-particulate-dispersant stream is atomized with the atomizing gas into liquid-particulate-dispersant droplets by the nozzle. In one or more embodiments, the liquid-particulate-dispersant stream is mixed with the atomizing gas. In one or more embodiments, the liquid-particulate-dispersant stream is directed into the atomizing nozzle thereby atomizing the particles into liquid-particulate-dispersant droplets. The liquid-particulate-dispersant droplets are comprised of the liquid vehicle, the particle dispersant, and the particles.

In one or more embodiments, the liquid-particulate-dispersant stream mixes with the atomizing gas via the atomizing nozzle. In one or more embodiments, the liquid-particulate-dispersant stream enters the atomizing nozzle. In one or more embodiments, the mixing of the liquid-particulate-dispersant stream with the atomizing gas occurs inside the atomizing nozzle. In one or more embodiments, the mixing of the liquid-particulate-dispersant stream with the atomizing gas occurs outside the atomizing nozzle.

In one or more embodiments, the suspension comprises an inorganic material, a liquid vehicle, a particle dispersant, and a binder, which is supplied to the nozzle as a liquid-particulate-dispersant-binder stream. That is, particles of an inorganic material can be mixed with a liquid vehicle, a particle dispersant, and a binder to form a liquid-particulate-dispersant-binder stream. The liquid-particulate-dispersant-binder stream is atomized with the atomizing gas into liquid-particulate-dispersant-binder droplets by the nozzle. In one or more embodiments, the liquid-particulate-dispersant-binder stream is mixed with the atomizing gas. In one or more embodiments, the liquid-particulate-dispersant-binder stream is directed into the atomizing nozzle thereby atomizing the particles into liquid-particulate-dispersant-binder droplets. The liquid-particulate-dispersant-binder droplets are comprised of the liquid vehicle, the particle dispersant, the binder, and the particles.

In one or more embodiments, the liquid-particulate-dispersant-binder stream mixes with the atomizing gas via the atomizing nozzle. In one or more embodiments, the liquid-particulate-dispersant-binder stream enters the atomizing nozzle. In one or more embodiments, the mixing of the liquid-particulate-dispersant-binder stream with the atomizing gas occurs inside the atomizing nozzle. In one or more embodiments, the mixing of the liquid-particulate-dispersant-binder stream with the atomizing gas occurs outside the atomizing nozzle.

Intermixing droplets and gaseous carrier stream 415. The droplets are conveyed toward the honeycomb body by a gaseous carrier stream. In one or more embodiments, the gaseous carrier stream comprises a carrier gas and the atomizing gas. In one or more embodiments, at least a portion of the carrier gas contacts the atomizing nozzle. In one or more embodiments, substantially all of the liquid vehicle is evaporated from the droplets to form agglomerates comprised of the particles and the binder.

In one or more embodiments, the gaseous carrier stream is heated prior to being mixed with the droplets. In one or more embodiments, the gaseous carrier stream is at a temperature in the range of from greater than or equal to 50° C. to less than or equal to 500° C., including all greater than or equal to 80° C. to less than or equal to 300° C., greater than or equal to 50° C. to less than or equal to 150° C., and all values and subranges therebetween. Without being bound to theory, it is believed that an advantage of a higher temperature is that the droplets evaporate faster and when the liquid is largely evaporated, they are less likely to stick when they collide. In certain embodiments, smaller agglomerates contribute to better filtration material deposits formation. Furthermore, it is believed that if droplets collide but contain only a small amount of liquid (such as only internally), the droplets may not coalesce to a spherical shape. In some embodiments, non-spherical agglomerates may provide desirable filtration performance.

In one or more embodiments, the atomizing gas is heated to form a heated atomizing gas, which is then flowed through and/or contacted with the nozzle. In one or more embodiments, the heated atomizing gas is at a temperature in the range of from greater than or equal to 50° C. to less than or equal to 500° C., including all greater than or equal to 80° C. to less than or equal to 300° C., greater than or equal to 50° C. to less than or equal to 150° C., and all values and subranges therebetween.

In one or more embodiments, both the carrier gas and the atomizing gas are independently heated and contacted with the nozzle. In one or more embodiments, the gaseous steam is heated, but the atomizing gas and the nozzle are maintained at a low temperature (approximately equal to room temperature, e.g., 25-40° C.). In one or more embodiments, the atomizing nozzle is cooled during the atomizing. In one or more embodiments, a temperature of the atomizing nozzle is maintained below a boiling point of the liquid vehicle.

The carrier gas is supplied to the apparatus to facilitate drying and carrying the liquid-particulate-binder droplets and resulting agglomerates through the apparatus and into the honeycomb body. In one or more embodiments, the carrier gas is predominantly an inert gas, such as nitrogen. In one or more embodiments, the carrier gas consists essentially of an inert gas. In one or more embodiments, the carrier gas is predominantly one or more inert gases. In one or more embodiments, the carrier gas is predominantly nitrogen gas. In one or more embodiments, the carrier gas is predominantly air. In one or more embodiments, the carrier gas consists essentially of nitrogen or air. In one or more embodiments, the carrier gas is dry. In one or more embodiments, the carrier gas comprises essentially no liquid vehicle upon entry to the chamber. In one or more embodiments, the carrier gas comprises less than 5 weight percent water vapor. In one or more embodiments, the carrier gas is heated prior to being mixed with the droplets. In one or more embodiments, the carrier gas is at a temperature in the range of from greater than or equal to 50° C. to less than or equal to 500° C., including all greater than or equal to 80° C. to less than or equal to 300° C., greater than or equal to 50° C. to less than or equal to 150° C., and all values and subranges therebetween.

In one or more embodiments, the atomizing gas and the carrier gas are independently delivered to the apparatus at a pressure of greater than or equal to 90 psi, including greater than or equal to 95 psi, greater than or equal to 100 psi, greater than or equal to 105 psi, greater than or equal to 100 psi, greater than or equal to 115 psi, or greater than or equal to 120 psi. In one or more embodiments, a booster provides the atomizing gas and the carrier gas at a desired pressure. The apparatus can comprise a diffusing area downstream of the nozzle. At least some of the intermixing of the gaseous carrier stream with the liquid-particulate-binder droplets occurs in the diffusing area.

Upon intermixing of the gaseous carrier stream with the liquid-particulate-binder droplets inside the chamber, a gas-liquid-particulate-binder mixture is formed. The gas-liquid-particulate-binder mixture is heated at the intermixing zone. In one or more embodiments, droplets of liquid containing particles and binder are present during the intermixing. In one or more embodiments, the gaseous carrier stream is heated prior to intermixing with the liquid-particulate-binder droplets.

In an embodiment, the carrier gas is delivered to the chamber in an annular co-flow surrounding the nozzle. In an embodiment, the carrier gas is delivered to a chamber of the duct in an annular flow surrounding the nozzle in a co-flow around the droplets at the end of the nozzle.

### Evaporation to Form Agglomerates 420.

To avoid liquid capillary force impact which may form non-uniform material which may result in high pressure drop penalty, the droplets are dried in an evaporation section of the apparatus, forming dry solid agglomerates, which may be referred to as secondary particles, or “microparticles” which are made up of primary nanoparticles and binder-type material. The liquid vehicle, or solvent, is evaporated and passes through the honeycomb body in a gaseous or vapor phase so that liquid solvent residual or condensation is minimized during material deposition. When the agglomerate is carried into the honeycomb body by gas flow, the residual liquid in the inorganic material should be less than 10 wt %. In some embodiments, all liquid is evaporated as a result of the drying and are converted into a gas or vapor phase. The liquid residual in some embodiments includes solvent in the mixture such water condensed from the gas phase. Binder is not considered as liquid residual, even if some or all of the binder may be in liquid or otherwise non-solid state before cure. In one or more embodiments, a total volumetric flow through the chamber is greater than or equal to 5 Nm³/hour and/or less than or equal to 200 Nm³/hour; including greater than or equal to 20 Nm³/hour and/or less than or equal to 100 Nm³/hour; and all values and subranges therebetween. Higher flow rates can deposit more material than lower flow rates. Higher flow rates can be useful as larger cross-sectional area filters are to be produced. Larger cross-sectional area filters may have applications in filter systems for building or outdoor filtration systems.

In one or more embodiments, substantially all of the liquid vehicle is evaporated from the droplets to form agglomerates of the particles and the binder, the agglomerates being interspersed in the gaseous carrier stream. In one or more embodiments, the apparatus has an evaporation section having an axial length which is sufficient to allow evaporation of at least a portion of the liquid vehicle, including a substantial portion and/or all of the liquid vehicle from the agglomerates.

Regarding flow, in an embodiment, a path of the droplets and a path of the gaseous carrier stream are substantially perpendicular prior to entering the evaporation section. In one or more embodiments, the carrier gas contacts the atomizing nozzle by way of a first path, and wherein a path of the droplets and a second path of the carrier gas are substantially perpendicular to each other prior to entering the evaporation section of the duct.

In another embodiment, a path of the droplets and a path of the gaseous carrier stream are substantially parallel upon entering the evaporation section. In one or more embodiments, a path of the droplets and a path of the gaseous carrier stream are substantially parallel to each other upon entering the evaporation section of the duct. In one or more embodiments, a path of the droplets and a path of the carrier gas are substantially parallel to each other upon entering an evaporation section of the duct.

In an embodiment, the gaseous carrier stream exits the chamber in a direction substantially parallel to gravity. In an embodiment, the gaseous carrier stream exits the chamber in a substantially downward direction. In an embodiment, the gaseous carrier stream exits the chamber in a substantially upward direction.

Deposition in honeycomb body 425. The secondary particles or agglomerates of the primary particles are carried in gas flow, and the secondary particles or agglomerates, and/or aggregates thereof, are deposited on inlet wall surfaces of the honeycomb body when the gas passes through the honeycomb body. In one or more embodiments, the agglomerates and/or aggregates thereof are deposited onto the porous walls of the plugged honeycomb body. The deposited agglomerates may be disposed on, or in, or both on and in, the porous walls. In one or more embodiments, the plugged honeycomb body comprises inlet channels which are plugged at a distal end of the honeycomb body, and outlet channels which are plugged at a proximal end of the honeycomb body. In one or more embodiments, the agglomerates and/or aggregates thereof are deposited on, or in, or both on and in, the walls defining the inlet channels. The flow can be driven by a fan, a blower or a vacuum pump. Additional air can be drawn into the system to achieve a desired flow rate. A desired flow rate is in the range of 5 to 200 m³/hr. One exemplary honeycomb body is suitable for use as a gasoline particular filter (GPF), and has the following non-limiting characteristics: diameter of 4.055 inches (10.3 cm), length of 5.47 inches (13.9 cm), cells per square inch (CPSI) of 200, wall thickness of 8 mils (203 microns), and bulk median pore size of 14 μm.

In one or more embodiments, the average diameter of the secondary particles or agglomerates is in a range of from 300 nm micron to 10 microns, 300 nm to 8 microns, 300 nm micron to 7 microns, 300 nm micron to 6 microns, 300 nm micron to 5 microns, 300 nm micron to 4 microns, or 300 nm micron to 3 microns. In specific embodiments, the average diameter of the secondary particles or agglomerates is in the range of 1.5 microns to 3 microns, including about 2 microns. The average diameter of the secondary particles or agglomerates can be measured by a scanning electron microscope.

In one or more embodiments, the average diameter of the secondary particles or agglomerates is in a range of from 300 nm to 10 microns, 300 nm to 8 microns, 300 nm to 7 microns, 300 nm to 6 microns, 300 nm to 5 microns, 300 nm to 4 microns, or 300 nm to 3 microns, including the range of 1.5 microns to 3 microns, and including about 2 microns, and there is a ratio in the average diameter of the secondary particles or agglomerates to the average diameter of the primary particles of in range of from about 2:1 to about 67:1; about 2:1 to about 9:1; about 2:1 to about 8:1; about 2:1 to about 7:1; about 2:1 to about 6:1; about 2:1 to about 5:1; about 3:1 to about 10:1; about 3:1 to about 9:1; about 3:1 to about 8:1; about 3:1 to about 7:1; about 3:1 to about 6:1; about 3:1 to about 5:1; about 4:1 to about 10:1; about 4:1 to about 9:1; about 4:1 to about 8:1; about 4:1 to about 7:1; about 4:1 to about 6:1; about 4:1 to about 5:1; about 5:1 to about 10:1; about 5:1 to about 9:1; about 5:1 to about 8:1; about 5:1 to about 7:1; or about 5:1 to about 6:1, and including about 10:1 to about 20:1.

In one or more embodiments, the depositing of the agglomerates onto the porous walls further comprises passing the gaseous carrier stream through the porous walls of the honeycomb body, wherein the walls of the honeycomb body filter out at least some of the agglomerates by trapping the filtered agglomerates on or in the walls of the honeycomb body. In one or more embodiments, the depositing of the agglomerates onto the porous walls comprises filtering the agglomerates from the gaseous carrier stream with the porous walls of the plugged honeycomb body.

Post-Treatment 430. A post-treatment may optionally be used to adhere the agglomerates to the honeycomb body, and/or to each other. That is, in one or more embodiments, at least some of the agglomerates adhere to the porous walls. In one or more embodiments, the post-treatment comprises heating and/or curing the binder according to one or more embodiments. In one or more embodiments, the binder causes the agglomerates to adhere or stick to the walls of the honeycomb body. In one or more embodiments, the binder tackifies the agglomerates.

Depending on the binder composition, the curing conditions are varied. According to some embodiments, a low temperature cure reaction is utilized, for example, at a temperature of ≤100° C. In some embodiments, the curing can be completed in the vehicle exhaust gas with a temperature ≤950° C. A calcination treatment is optional, which can be performed at a temperature ≤650° C. Exemplary curing conditions are: a temperature range of from 40° C. to 200° C. for 10 minutes to 48 hours.

In one or more embodiments, the agglomerates and/or aggregates thereof are heated after being deposited on the honeycomb body. In one or more embodiments, the heating of the agglomerates causes an organic component of the binder to be removed from the deposited agglomerates. In one or more embodiments, the heating of the agglomerates causes an inorganic component of the binder to physically bond the agglomerates to the walls of the honeycomb body. In one or more embodiments, the heating of the agglomerates causes an inorganic component of the binder to form a porous inorganic structure on the porous walls of the honeycomb body. In one or more embodiments, the heating of the deposited agglomerates burns off or volatilizes an organic component of the binder from the deposited agglomerates.

In an aspect, methods for applying a surface treatment to a plugged honeycomb body comprising a honeycomb structure of a plurality of axial porous walls defining a plurality of axial channels in an axial direction comprise: atomizing a dispersion of particles of an inorganic material into liquid-particulate-dispersant droplets comprised of: a liquid vehicle comprising methanol, acetone, hexane, or combinations thereof; a particle dispersant comprising: triethanolamine, triethoxyvinylsilane, vinyltrimethoxysilane, 5-hexanyltrimethoxysaline, or combinations thereof, and the particles; evaporating substantially all of at least the liquid vehicle from the droplets to form agglomerates of the particles; and depositing the agglomerates within the plugged honeycomb body; wherein the deposited agglomerates are disposed on, or in, or both on and in, the porous walls.

In one or more embodiments, the method further comprises atomizing a binder with the dispersion such that the droplets are liquid-particulate-dispersant-binder droplets and the agglomerates further comprise the binder. In one or more embodiments, the atomizing further comprises supplying a suspension of the particles, the liquid vehicle, and the particle dispersant.

In one or more embodiments, when the liquid vehicle comprises the methanol, the particle dispersant comprises the triethanolamine; or when the liquid vehicle comprises the acetone, the particle dispersant comprises the triethoxyvinylsilane or the vinyltrimethoxysilane; or when the liquid vehicle comprises the hexane, the particle dispersant comprises the 5-hexanyltrimethoxysaline.

In one or more embodiments, the agglomerates comprise a volume-based average particle diameter (D₅₀) for a given set of operating conditions that is smaller than a comparative volume-based average particle diameter (D₅₀) of comparative agglomerates formed by a method using the given set of operating conditions except for use of ethanol as the liquid vehicle.

Another aspect provides methods for applying a surface treatment to a plugged honeycomb body comprising a honeycomb structure of a plurality of axial porous walls defining a plurality of axial channels in an axial direction comprise: atomizing a dispersion of particles of an inorganic material into liquid-particulate-dispersant-binder droplets consisting essentially of: a liquid vehicle comprising methanol, acetone, hexane, or combinations thereof, a particle dispersant, a binder, and the particles; evaporating substantially all of at least the liquid vehicle from the droplets to form agglomerates of the particles; and depositing the agglomerates within the plugged honeycomb body; wherein the deposited agglomerates are disposed on, or in, or both on and in, the porous walls.

In one or more embodiments, the particle dispersant comprising: triethanolamine, triethoxyvinylsilane, vinyltrimethoxysilane, 5-hexanyltrimethoxysaline, or combinations thereof.

In one or more embodiments, the atomizing further comprises supplying a suspension of the particles, the liquid vehicle, the binder and the particle dispersant.

In one or more embodiments, the agglomerates comprise a volume-based average particle diameter (D₅₀) for a given set of operating conditions that is smaller than a comparative volume-based average particle diameter (D₅₀) of comparative agglomerates formed by a method using the given set of operating conditions except for use of ethanol only as the liquid vehicle.

In another aspect, methods for applying a surface treatment to a plugged honeycomb body comprising a honeycomb structure of a plurality of axial porous walls defining a plurality of axial channels in an axial direction comprise: atomizing a dispersion of particles of an inorganic material into liquid-particulate-dispersant droplets comprised of: a liquid vehicle comprising water and one or more solvents having a lower boiling point than the water, a particle dispersant, and the particles; evaporating substantially all of at least the liquid vehicle from the droplets to form agglomerates of the particles; and depositing the agglomerates within the plugged honeycomb body; wherein the deposited agglomerates are disposed on, or in, or both on and in, the porous walls.

In one or more embodiments, the atomizing further comprises a binder with the dispersion such that the droplets are liquid-particulate-dispersant-binder droplets and the agglomerates further comprise the binder. In one or more embodiments, the atomizing further comprises supplying a suspension of the particles, the liquid vehicle, and the particle dispersant. In one or more embodiments, the one or more solvents comprise ethanol, methanol, acetone, hexane, or combinations thereof. In one or more embodiments, the particle dispersant comprises acetic acid, triethanolamine, triethoxyvinylsilane, vinyltrimethoxysilane, and/or 5-hexanyltrimethoxysaline.

In one or more embodiments, the agglomerates comprise a volume-based average particle size (D₅₀) for a given set of operating conditions that is smaller than a comparative volume-based average particle diameter (D₅₀) of comparative agglomerates formed by a method using the given set of operating conditions except for use of water only as the liquid vehicle.

An aspect is a filtration article prepared according to any method herein comprising a filtration efficiency of greater than or equal to 95.0% and a loading of the deposited agglomerates of less than or equal to 6 grams of the deposited agglomerates per liter of the honeycomb filter body. In one or more embodiments, the filtration efficiency is greater than or equal to 99.0%. In one or more embodiments, the loading of the deposited agglomerates is greater than or equal to 2 grams of the deposited agglomerates per liter of the honeycomb filter body. In one or more embodiments, the loading of the deposited agglomerates is less than or equal to 3 grams of the deposited agglomerates per liter of the honeycomb filter body.

### Apparatus

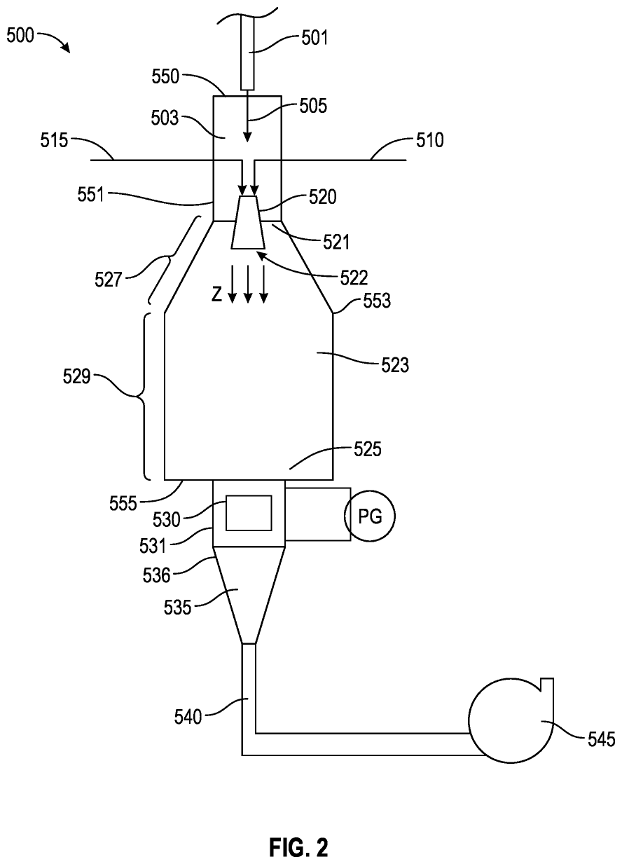

Examples of apparatuses that may be used for processes to deposit inorganic material with binder on ceramic honeycomb bodies are shown in FIGS. 2-6. Generally, apparatuses suitable for methods herein include a duct that defines a chamber. The duct may have several sections defining differing spaces and chambers. In one or more embodiments, the droplets and the gaseous carrier stream are conveyed through a duct having an outlet end proximate a plugged honeycomb body. The duct may comprise a converging section for engaging a proximal end of the honeycomb body. A converging section is advantageous in that fluid convection flow is enhanced. The duct may be in sealed fluid communication with the plugged honeycomb body during the depositing step. In one or more embodiments, the duct is adiabatic, or essentially adiabatic. In some embodiments, the nozzle temperature is regulated to achieve favorable atomization.

In some embodiments, a round cross-section chamber can facilitate keeping agglomerates entrained in the gaseous carrier stream. In various embodiments, a round cross-sectional duct reduces and/or prevents recirculation regions or “dead-zones” that can be the result of, for example, corners being present.

In one or more embodiments, an average temperature of walls of the duct is less than a temperature of the gaseous carrier stream. In one or more embodiments, an average temperature of walls of the duct is greater than a temperature of the gaseous carrier stream.

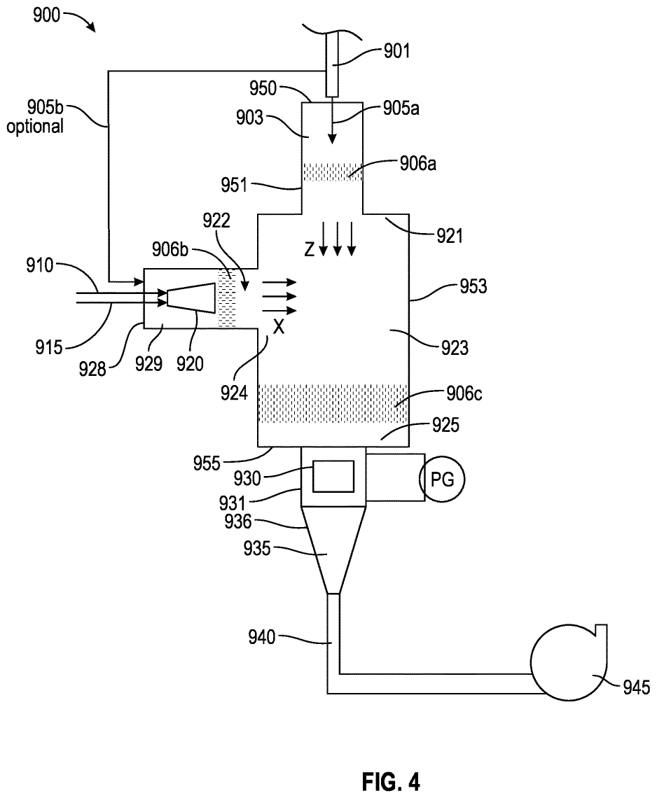

In the following, FIGS. 2-3 and 5-6 schematically show co-flow where a path of the droplets and a path of the gaseous carrier stream are substantially parallel upon entering the evaporation section. FIG. 4 shows the carrier gas contacting an atomizing nozzle by way of a first path, and wherein a path of the droplets and a second path of the carrier gas are substantially perpendicular to each other prior to entering the evaporation section of the duct.

FIG. 2 shows an apparatus 500 for depositing filtration material, including inorganic material according to embodiments herein, the apparatus 500 comprising a duct 551, a deposition zone 531, an exit zone 536, an exit conduit 540, and a flow driver 545.

The duct 551 spans from a first end 550 to a second end 555, defining a chamber of the duct comprising: a plenum space 503 at the first end 550 and an evaporation chamber 523 downstream of the plenum space 503. In one or more embodiments, the duct 551 is essentially adiabatic. That is, the duct 551 may have no external sources of heat. The evaporation chamber 523 is defined by an evaporation section 553 of the duct 551, which in this embodiment; comprises a first section of non-uniform diameter 527 and a second section of substantially uniform diameter 529. The evaporation section 553 comprises an inlet end 521 and an outlet end 525. The first section of non-uniform diameter 527 has a diameter that increases from the inlet end 521 toward the section of uniform diameter 529, which creates a diverging space for the flow to occupy.

A carrier gas is supplied to the duct 551 by a conduit 501, which may have a heat source to create a heated carrier gas 505. An atomizing gas 515 and a suspension 510 are separately supplied by individual delivery conduits such as tubing or piping to a nozzle 520, which is at the inlet end 521 of the evaporation section 553 and is in fluid communication with the duct 551, specifically in this embodiment with the evaporation chamber 523. The suspension 510 is atomized in the nozzle 520 with the atomizing gas 515. In one or more embodiments, the suspension 510 comprises an inorganic material, a liquid vehicle, and a particle dispersant, which as supplied to the nozzle is a liquid-particulate-dispersant stream. The liquid-particulate-dispersant stream is atomized with the atomizing gas 515 into liquid-particulate-dispersant droplets by the nozzle 520. In one or more other embodiments, the suspension 510 comprises an inorganic material, a liquid vehicle, a particle dispersant, and a binder, which as supplied to the nozzle is a liquid-particulate-dispersant-binder stream. The liquid-particulate-dispersant-binder stream is atomized with the atomizing gas 515 into liquid-particulate-dispersant-binder droplets by the nozzle 520.

In one or more embodiments, the heated carrier gas 505 flows over the nozzle 520. The atomizing gas 515 can be heated to form a heated atomizing gas. Temperature of the nozzle may be regulated as desired.

Outlet flow from the nozzle 520 and flow of the heated carrier gas 505 are both in a “Z” direction as shown in FIG. 2. There may be a diffusing area 522 downstream of the nozzle where at least some intermixing occurs. In this embodiment, the diffusing area 522 is located in the evaporation chamber 523, but in other embodiments, the diffusing area 522 may be located in the plenum space 503 depending on the location of the nozzle.

The outlet flow of from the nozzle intermixes with the heated carrier gas 505, thereby forming a gas-liquid-particulate mixture or a gas-liquid-particulate-binder mixture, which flows through the chamber of the duct 551. Specifically, the gas-liquid-particulate or the gas-liquid-particulate-binder mixture flows through the evaporation chamber 523 of the evaporation section 553 and into the deposition zone 531 at the outlet end 525 of the evaporation section 553. At the intermixing, the gas-liquid-particulate or the gas-liquid-particulate-binder mixture is heated inside the chamber by the heated carrier gas.

In this embodiment, the outlet flow of the nozzle and the heated carrier gas enter the evaporation chamber 523 of the evaporation section 553 from substantially the same direction. In the evaporation chamber 523, substantially all of the liquid vehicle and dispersant from the droplets is evaporated thereby forming agglomerates of the particles, or the particles and the binder, the agglomerates being interspersed in a gaseous carrier stream, which is comprised of the carrier gas and the atomizing gas.

The deposition zone 531 in fluid communication with the duct 551 houses a plugged ceramic honeycomb body 530, for example, a wall-flow particulate filter. The deposition zone 531 has an inner diameter that is larger than the outer diameter of the ceramic honeycomb body 530. To avoid leakage of the gases carrying the ceramic powders, the ceramic honeycomb body 530 is sealed to the inner diameter of deposition zone 531, a suitable seal is, for example, an inflatable “inner tube”. A pressure gauge, labelled as “PG,” measures the difference in the pressure upstream and downstream from the particulate filter.

The gas-liquid-particulate mixture or the gas-liquid-particulate-binder mixture flows into the ceramic honeycomb body 530 thereby depositing the inorganic material of the suspension on the ceramic honeycomb body. Specifically, the agglomerates and the gaseous carrier stream pass into the honeycomb body such that the gaseous carrier stream passes through the porous walls of the honeycomb body, and the walls of the honeycomb body trap the agglomerates, wherein the agglomerates and/or aggregates thereof are deposited on or in the walls of the honeycomb body. The inorganic material binds to the ceramic honeycomb body upon post-treatment to the ceramic honeycomb body. In an embodiment, binder material causes the agglomerates to adhere or stick to the walls of the honeycomb body.

Downstream from the ceramic honeycomb body 530 is an exit zone 536 defining an exit chamber 535. The flow driver 545 is downstream from the ceramic honeycomb body 530, in fluid communication with the deposition zone 531 and the exit zone 536 by way of the exit conduit 540. Non-limiting examples of flow drivers are: a fan, a blower, and a vacuum pump. The aerosolized suspension is dried and deposited on one or more walls of the particulate filter as agglomerates of filtration material, which is present as discrete regions of filtration material, or in some portions or some embodiments as a layer, or both, wherein the agglomerates are comprised of primary particles of inorganic material.

Flow through embodiments such as apparatus 500 is considered in a downward direction, for example, substantially parallel to the direction of gravity. In other embodiments, the apparatus is configured such that flow is directed in a substantially upward or vertical direction.

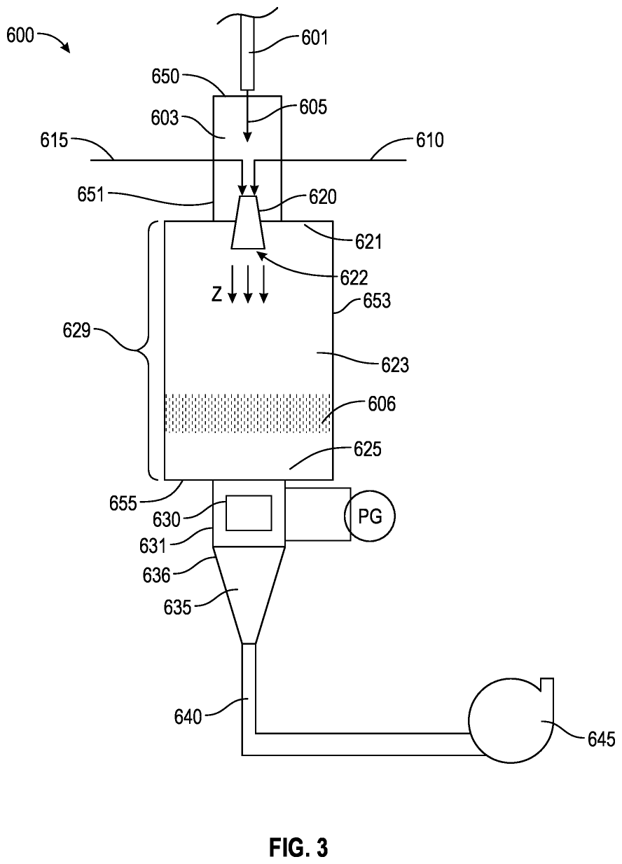

In FIG. 3, an apparatus 600 for depositing filtration material including inorganic material according to embodiments herein is shown comprising a duct 651, a deposition zone 631, an exit zone 636, an exit conduit 640, and a flow driver 645.

The duct 651 spans from a first end 650 to a second end 655, defining a chamber of the duct comprising: a plenum space 603 at the first end 650 and an evaporation chamber 623 downstream of the plenum space 603. In one or more embodiments, the diameter of the duct 651 defining the plenum space 603 can be equal to the diameter of the evaporation section 653 of the duct 651 defining the evaporation chamber 623. In one or more embodiments, the duct 651 is essentially adiabatic. That is, the duct 651 may have no external sources of heat. The evaporation chamber 623, in this embodiment, comprises a single section of substantially uniform diameter 629. The evaporation section 653 comprises an inlet end 621 and an outlet end 625.

A carrier gas is supplied to the duct 651 by a conduit 601, which may have a heat source to create a heated carrier gas 605. An atomizing gas 615 and a suspension 610 are separately supplied by individual delivery conduits such as tubing or piping to a nozzle 620, which is at the inlet end 621 of the evaporation section 653 and is in fluid communication with the duct 651, specifically in this embodiment with the evaporation chamber 623. The suspension 610 is atomized in the nozzle 620 with the atomizing gas 615. In one or more embodiments, the suspension 610 comprises an inorganic material, a liquid vehicle, and a particle dispersant, which as supplied to the nozzle is a liquid-particulate-dispersant stream. The liquid-particulate-dispersant stream is atomized with the atomizing gas 615 into liquid-particulate-dispersant droplets by the nozzle 620. In one or more other embodiments, the suspension 610 comprises an inorganic material, a liquid vehicle, a particle dispersant, and a binder, which as supplied to the nozzle is a liquid-particulate-dispersant-binder stream. The liquid-particulate-dispersant-binder stream is atomized with the atomizing gas 615 into liquid-particulate-dispersant-binder droplets by the nozzle 620. In one or more embodiments, the heated carrier gas 605 flows over the nozzle 620. The atomizing gas 615 can be heated to form a heated atomizing gas. The temperature of the nozzle may be regulated as desired.

Outlet flow from the nozzle 620 and flow of the heated carrier gas 605 are both in a “Z” direction as shown in FIG. 3. In specific embodiments, a diffusing area 622 is downstream of the nozzle where at least some intermixing occurs. In this embodiment, the diffusing area 622 is located in the evaporation chamber 623, but in other embodiments the diffusing area may be located in the plenum space 603 depending on the location of the nozzle.

The outlet flow from the nozzle intermixes with the heated carrier gas 605, thereby forming a gas-liquid-particulate mixture or a gas-liquid-particulate-binder mixture, which flows through the chamber of the duct 651. Specifically, the gas-liquid-particulate mixture or the gas-liquid-particulate-binder mixture flows through the evaporation chamber 623 of the evaporation section 653 and into the deposition zone 631 at the outlet end 625 of the evaporation section 653. At the intermixing, the gas-liquid-particulate mixture or the gas-liquid-particulate-binder mixture is heated inside the chamber by the heated carrier gas.

In this embodiment, the outlet flow of the nozzle and the carrier gas enter the evaporation chamber 623 of the evaporation section 653 from substantially the same direction. In the evaporation chamber 623, substantially all of the liquid vehicle from the droplets is evaporated thereby forming agglomerates of the particles, or the particles and the binder, the agglomerates being interspersed in a gaseous carrier stream, which is comprised of the carrier gas and the atomizing gas.

The deposition zone 631 in fluid communication with the duct 651 houses a plugged ceramic honeycomb body 630, for example, a wall-flow particulate filter. The deposition zone 631 has an inner diameter that is larger than the outer diameter of the ceramic honeycomb body 630. To avoid leakage of the gases carrying the ceramic powders, the ceramic honeycomb body 630 is sealed to the inner diameter of the deposition zone 631, a suitable seal is, for example, an inflatable “inner tube”. A pressure gauge, labelled as “PG” measures the difference in the pressure upstream and downstream from the particulate filter. The gas-liquid-particulate-binder mixture flows into the ceramic honeycomb body 630 thereby depositing the inorganic material of the suspension on the ceramic honeycomb body. Specifically, the agglomerates and the gaseous carrier stream pass into the honeycomb body such that the gaseous carrier stream passes through the porous walls of the honeycomb body, and the walls of the honeycomb body trap the agglomerates, wherein the agglomerates are deposited on or in the walls of the honeycomb body. The inorganic material binds to the ceramic honeycomb body upon post-treatment to the ceramic honeycomb body. In an embodiment, binder material causes the agglomerates to adhere or stick to the walls of the honeycomb body.

Downstream from the ceramic honeycomb body 630 is an exit zone 636 defining an exit chamber 635. The flow driver 645 is downstream from the ceramic honeycomb body 630, in fluid communication with the deposition zone 631 and the exit zone 636 by way of the exit conduit 640. Non-limiting examples of flow drivers are: fan, blower, and vacuum pump. The aerosolized suspension is dried and deposited on one or more walls of the particulate filter as agglomerates of filtration material, which is present as discrete regions of filtration material, or in some portions or some embodiments as a layer, or both, wherein the agglomerates are comprised of primary particles of inorganic material.

Flow through embodiments such as apparatus 600 is considered in a downward direction, for example, substantially parallel to the direction of gravity. In other embodiments, the apparatus is configured such that flow is directed in a substantially upward or vertical direction.

In FIG. 4, an apparatus 900 for depositing filtration material including inorganic material according to embodiments herein is shown comprising a duct 951, a deposition zone 931, an exit zone 936, an exit conduit 940, and a flow driver 945.

The duct 951 spans from a first end 950 to a second end 955 including a right cylindrical section 928, all defining a chamber of the duct comprising: a first plenum space 903 at the first end 950, an evaporation chamber 923 downstream of the plenum space 903, and a second plenum space 929 defined by the right cylindrical section 928. In one or more embodiments, the diameter of the duct 951 defining the plenum space 903 can be equal to the diameter of a first inlet location 921 of an evaporation section 953 of the duct 951. In one or more embodiments, the duct 951 is essentially adiabatic. That is, the duct 951 may have no external sources of heat. The evaporation chamber 923 is defined by the evaporation section 953 of the duct 951. The evaporation section 953 comprises the first inlet location 921 from the first plenum space 903, a second inlet location 924 from the second plenum space 929, and an outlet end 925. In some embodiments, some evaporation may occur in at least a portion of second plenum space 929 defined by the right cylindrical section 928.

A carrier gas is supplied in a first path to the duct 951 by a conduit 901, which may have a first heat source 906a to create a primary heated carrier gas 905a that enters the first plenum space 903, and optionally another secondary heated carrier gas 905b that enters the second plenum space 929 by a second path. An atomizing gas 915 and a suspension 910 are separately supplied by individual delivery conduits such as tubing or piping to a nozzle 920, which is in the second plenum space 929 of the right cylindrical section 928 and is in fluid communication with the evaporation chamber 923 of the evaporation section 953. The suspension 910 is atomized in the nozzle 920 with the atomizing gas 915. the suspension may be contained in a suspension container, and liquid pressure can be applied and controlled by a gas supply, which in some embodiments is in the form of a cylinder. In one or more embodiments, pressure is controlled by a digital automatic pressure regulator or a piezo actuator valve. Atomization gas according to one or more embodiments comprises nitrogen or air. In one or more embodiments, the suspension 910 comprises an inorganic material, a liquid vehicle, and a particle dispersant, which as supplied to the nozzle is a liquid-particulate-dispersant stream. The liquid-particulate-dispersant stream is atomized with the atomizing gas 915 into liquid-particulate-dispersant droplets by the nozzle 920. In one or more other embodiments, the suspension 910 comprises an inorganic material, a liquid vehicle, a particle dispersant, and a binder, which as supplied to the nozzle is a liquid-particulate-dispersant-binder stream. The liquid-particulate-dispersant-binder stream is atomized with the atomizing gas 915 into liquid-particulate-dispersant-binder droplets by the nozzle 920.

In one or more embodiments, the secondary heated carrier gas 905b flows over the nozzle 920 Temperature of the nozzle may be regulated as desired. A second heat source 906b is positioned downstream from the nozzle 920 to heat the suspension 910 that is atomized in the nozzle 920.

Outlet flow from the nozzle 920 and, when present, flow of the secondary heated carrier gas 905b are both is in an “X” direction as shown in FIG. 4. Flow of the primary heated carrier gas 905a is in a “Z” direction as shown in FIG. 4. There may be a diffusing area 922 downstream of the nozzle where at least some intermixing occurs. In this embodiment, the diffusing area 922 is located at least partially in the second plenum space 929, but in other embodiments, the diffusing area 922 may be located in evaporation chamber 923 depending on the location of the nozzle.

The outlet flow of from the nozzle intermixes with the heated carrier gases 905a and 905b, thereby forming a gas-liquid-particulate mixture or a gas-liquid-particulate-binder mixture, which flows through the chamber of the duct 951. Specifically, the gas-liquid-particulate mixture or the gas-liquid-particulate-binder mixture flows through the evaporation chamber 923 of the evaporation section 953 and into the deposition zone 931 at the outlet end 925 of the evaporation section 953. At the intermixing, the gas-liquid-particulate mixture or the gas-liquid-particulate-binder mixture is heated inside the chamber by the heated carrier gas. A third heat source 906c is positioned in the evaporation chamber 923, and the outlet flow of the nozzle and the primary carrier gas 905a enter the evaporation chamber 923 of the evaporation section 953.

In this embodiment, the outlet flow of the nozzle and the primary carrier gas 905a enter the evaporation chamber 923 of the evaporation section 953 from substantially perpendicular directions. In the evaporation chamber 923, substantially all of the liquid vehicle from the droplets is evaporated thereby forming agglomerates of the particles, or the particles and the binder, the agglomerates being interspersed in a gaseous carrier stream, which is comprised of the carrier gases and the atomizing gas.

The deposition zone 931 in fluid communication with the duct 951 houses a plugged ceramic honeycomb body 930, for example, a wall-flow particulate filter. The deposition zone 931 has an inner diameter that is larger than the outer diameter of the ceramic honeycomb body 930. To avoid leakage of the gases carrying the ceramic powders, the ceramic honeycomb body 930 is sealed to the inner diameter of the deposition zone 931, a suitable seal is, for example, an inflatable “inner tube”. A pressure gauge, labelled as “PG,” measures the difference in the pressure upstream and downstream from the particulate filter. The gas-liquid-particulate-binder mixture flows into the ceramic honeycomb body 930 thereby depositing the inorganic material of the suspension on the ceramic honeycomb body. Specifically, the agglomerates and the gaseous carrier stream pass into the honeycomb body such that the gaseous carrier stream passes through the porous walls of the honeycomb body, and the walls of the honeycomb body trap the agglomerates, wherein the agglomerates are deposited on or in the walls of the honeycomb body. The inorganic material binds to the ceramic honeycomb body upon post-treatment to the ceramic honeycomb body. In an embodiment, binder causes the agglomerates to adhere or stick to the walls of the honeycomb body.

Downstream from the ceramic honeycomb body 930 is an exit zone 936 defining an exit chamber 935. The flow driver 945 is downstream from the ceramic honeycomb body 930, in fluid communication with the deposition zone 931 and the exit zone 936 by way of the exit conduit 940. Non-limiting examples of flow drivers are: fan, blower, and vacuum pump. The aerosolized suspension is dried and deposited on one or more walls of the particulate filter as agglomerates of filtration material, which is present as discrete regions of filtration material, or in some portions or some embodiments as a layer, or both, wherein the agglomerates are comprised of primary particles of inorganic material.

Overall flow through embodiments such as apparatus 900 is considered in a downward direction, for example, substantially parallel to the direction of gravity. In other embodiments, the apparatus is configured such that flow is directed in a substantially upward or vertical direction.

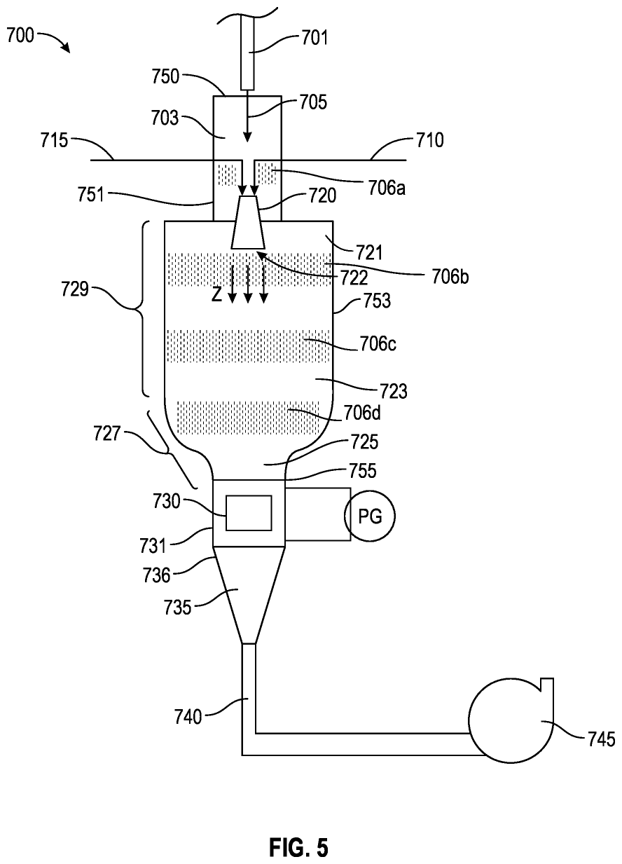

FIG. 5 shows an apparatus 700 for depositing filtration material including inorganic material according to embodiments herein, the apparatus 700 comprising a duct 751, a deposition zone 731, an exit zone 736, an exit conduit 740, and a flow driver 745.

The duct 751 spans from a first end 750 to a second end 755, defining a chamber of the duct comprising: a plenum space 703 at the first end 750 and an evaporation chamber 723 downstream of the plenum space 703. In one or more embodiments, the diameter of the duct 751 defining the plenum space 703 can be equal to the diameter of an evaporation section 753 at an inlet end 721. In one or more embodiments, the duct 751 is essentially adiabatic. That is, the duct 751 may have no external sources of heat. The evaporation chamber 723 is defined by the evaporation section 753 of the duct 751, which in this embodiment, comprises a first section of non-uniform diameter 727 and a second section of substantially uniform diameter 729. The evaporation section 753 comprises the inlet end 721 and an outlet end 725. The first section of non-uniform diameter 727 has a diameter that decreases from the outlet end 725 toward the section of uniform diameter 729, which creates a converging space for the flow as it enters the deposition zone 731.

A carrier gas is supplied to the duct 751 by a conduit 701, which may have a heat source to create a heated carrier gas 705. An atomizing gas 715 and a suspension 710 are separately supplied by individual delivery conduits such as tubing or piping to a nozzle 720, which is at the inlet end 721 of the evaporation section 753 and is in fluid communication with the duct 751, specifically in this embodiment with the evaporation chamber 723. The suspension 710 is atomized in the nozzle 720 with the atomizing gas 715. In one or more embodiments, the suspension 710 comprises an inorganic material, a liquid vehicle, and a particle dispersant, which as supplied to the nozzle is a liquid-particulate-dispersant stream. The liquid-particulate-dispersant stream is atomized with the atomizing gas 715 into liquid-particulate-dispersant droplets by the nozzle 720. In one or more other embodiments, the suspension 710 comprises an inorganic material, a liquid vehicle, a particle dispersant and a binder, which as supplied to the nozzle is a liquid-particulate stream. The liquid-particulate-binder stream is atomized with the atomizing gas 715 into liquid-particulate-binder droplets by the nozzle 720.

In one or more embodiments, the heated carrier gas 705 flows over the nozzle 720. The atomizing gas 715 can be heated to form a heated atomizing gas. Temperature of the nozzle may be regulated as desired.

Outlet flow from the nozzle 720 and flow of the heated carrier gas 705 are both in a “Z” direction as shown in FIG. 5. There may be a diffusing area 722 downstream of the nozzle where at least some intermixing occurs. In this embodiment, the diffusing area 722 is located in the evaporation chamber 723, but in other embodiments, the diffusing area may be located in the plenum space 703 depending on the location of the nozzle.

The outlet flow of from the nozzle intermixes with the heated carrier gas 705, thereby forming a gas-liquid-particulate mixture or a gas-liquid-particulate-binder mixture, which flows through the chamber of the duct 751. Specifically, the gas-liquid-particulate mixture or the gas-liquid-particulate-binder mixture flows through the evaporation chamber 723 of the evaporation section 753 and into the deposition zone 731 at the outlet end 725 of the evaporation section 753. At the intermixing, the gas-liquid-particulate mixture or the gas-liquid-particulate-binder mixture is heated inside the chamber by the heated carrier gas.

In this embodiment, the outlet flow of the nozzle and the heated carrier gas enter the evaporation chamber 723 of the evaporation section 753 from substantially the same direction. In the evaporation chamber 723, substantially all of the liquid vehicle from the droplets is evaporated thereby forming agglomerates of the particles, or the particles and the binder, the agglomerates being interspersed in a gaseous carrier stream, which is comprised of the carrier gas and the atomizing gas.

The deposition zone 731 in fluid communication with the duct 751 houses a plugged ceramic honeycomb body 730, for example, a wall-flow particulate filter. The deposition zone 731 has an inner diameter that is larger than the outer diameter of the ceramic honeycomb body 730. To avoid leakage of the gases carrying the ceramic powders, the ceramic honeycomb body 730 is sealed to the inner diameter of the deposition zone 731, a suitable seal is, for example, an inflatable “inner tube”. A pressure gauge, labelled as “PG” measures the difference in the pressure upstream and downstream from the particulate filter. The gas-liquid-particulate-binder mixture flows into the ceramic honeycomb body 730 thereby depositing the inorganic material of the suspension on the ceramic honeycomb body. Specifically, the agglomerates and the gaseous carrier stream pass into the honeycomb body such that the gaseous carrier stream passes through the porous walls of the honeycomb body, and the walls of the honeycomb body trap the agglomerates, wherein the agglomerates and/or aggregates thereof are deposited on or in the walls of the honeycomb body. The inorganic material binds to the ceramic honeycomb body upon post-treatment to the ceramic honeycomb body. In an embodiment, binder causes the agglomerates to adhere or stick to the walls of the honeycomb body.

Downstream from the ceramic honeycomb body 730 is an exit zone 736 defining an exit chamber 735. The flow driver 745 is downstream from the ceramic honeycomb body 730, in fluid communication with the deposition zone 731 and the exit zone 736 by way of the exit conduit 740. Non-limiting examples of flow drivers are: fan, blower, and vacuum pump. The droplets of the atomized suspension are aerosolized and dried and deposited on one or more walls of the particulate filter as agglomerates of filtration material, which is present as discrete regions of filtration material, or in some portions or some embodiments as a layer, or both, wherein the agglomerates are comprised of primary particles of inorganic material.

Flow through embodiments such as apparatus 700 is considered in a downward direction, for example, substantially parallel to the direction of gravity. In other embodiments, the apparatus is configured such that flow is directed in a substantially upward or vertical direction.

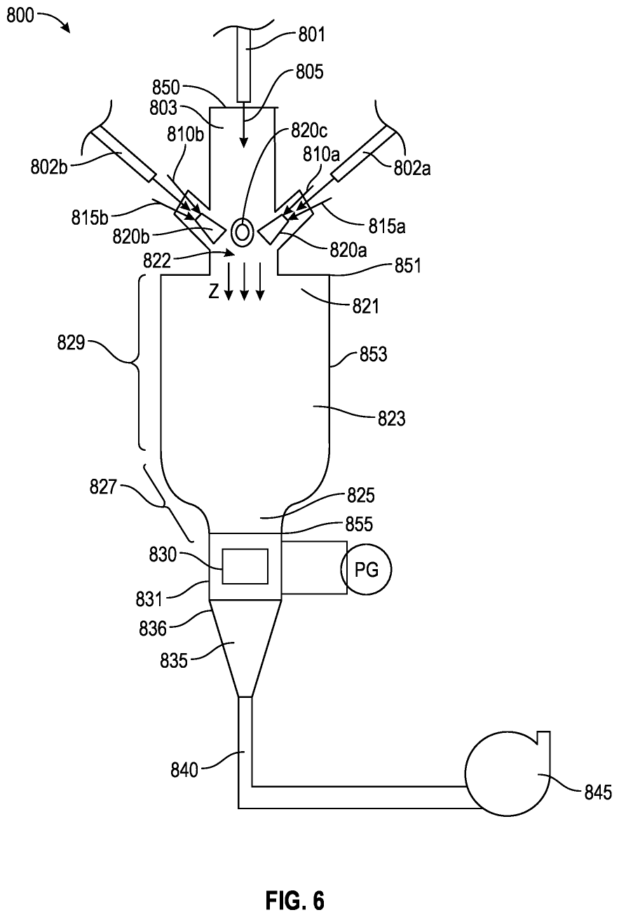

FIG. 6 shows an apparatus 800 for depositing filtration material including inorganic material according to embodiments herein, the apparatus 800 comprising a duct 851, a deposition zone 831, an exit zone 836, an exit conduit 840, and a flow driver 845.

The duct 851 spans from a first end 850 to a second end 855, defining a chamber of the duct comprising: a plenum space 803 at the first end 850 and an evaporation chamber 823 downstream of the plenum space 803. In one or more embodiments, the duct 851 is essentially adiabatic. That is, the duct 851 may have no external sources of heat. The evaporation chamber 823 is defined by an evaporation section 853 of the duct 851, which in this embodiment, comprises a first section of non-uniform diameter 827 and a second section of substantially uniform diameter 829. The evaporation section 853 comprises an inlet end 821 and an outlet end 825. The first section of non-uniform diameter 827 has a diameter that decreases from the outlet end 825 toward the section of uniform diameter 829, which creates a converging space for the flow as it enters the deposition zone 831. In some embodiments, the evaporation section 853 is configured to have a single section of substantially uniform diameter analogous to FIG. 3. Alternatively, the evaporation section 853 has a section of non-uniform diameter that increases from the inlet end 821 toward a section of uniform diameter analogous to FIG. 2.

A carrier gas is supplied to the duct 851 by a conduit 801, which may have a heat source to create a heated carrier gas 805. An atomizing gas 815 and a suspension 810 are separately supplied by individual delivery conduits such as tubing or piping to a plurality of nozzles 820a, 820b, and 820c, which are in fluid communication with the plenum space 803. Each nozzle has an inflow of the atomizing gas e.g., 815a supplies the nozzle 820a and 815b supplies the nozzle 820b. Each nozzle has an inflow of the suspension e.g., 810a supplies the nozzle 820a and 810b supplies the nozzle 820b. Optionally, each nozzle has a supply of the heated carrier gas, e.g., 802a supplies the nozzle 820a and 802b supplies the nozzle 820b. While the embodiment of FIG. 6 shows three nozzles, in other embodiments, a plurality of nozzles of any number is be used. The suspension 810 is atomized in the nozzle 820 with the atomizing gas 815. In one or more embodiments, the suspension 810 comprises an inorganic material, a liquid vehicle, and a particle dispersant, which as supplied to the nozzle is a liquid-particulate-dispersant stream. The liquid-particulate-dispersant stream is atomized with the atomizing gas 815 into liquid-particulate-dispersant droplets by the nozzle 820. In one or more other embodiments, the suspension 810 comprises an inorganic material, a liquid vehicle, a particle dispersant, and a binder, which as supplied to the nozzle is a liquid-particulate-dispersant-binder stream. The liquid-particulate-dispersant-binder stream is atomized with the atomizing gas 815 into liquid-particulate-dispersant-binder droplets by the nozzle 820.

In one or more embodiments, the heated carrier gas 805 and optionally 802a and 802b flow over the nozzles. The atomizing gas 815a and 815b can be heated to form a heated atomizing gas. Temperatures of the nozzles may be regulated, individually or collectively, as desired.

Flow of the heated carrier gas 805 is in a “Z” direction as shown in FIG. 6. While outlet flow from the nozzles 820a, 820b, and 820c may be angled towards a center of the duct 851, upon intermixing with the heated carrier gas 805, the outlet flow of the nozzles will generally be in the “Z” direction. There may be a diffusing area 822 downstream of the nozzles where at least some intermixing occurs. In this embodiment, the diffusing area 822 is located in the plenum space 803, but in other embodiments, the diffusing area may be located in the evaporation chamber 823 depending on the location of the nozzles.

The outlet flow of from the nozzles intermixes with the heated carrier gas 805, thereby forming a gas-liquid-particulate mixture or a gas-liquid-particulate-binder mixture, which flows through the chamber of the duct 851. Specifically, the gas-liquid-particulate mixture or the gas-liquid-particulate-binder mixture flows through the evaporation chamber 823 of the evaporation section 853 and into the deposition zone 831 at the outlet end 825 of the evaporation section 853. At the intermixing, the gas-liquid-particulate mixture or the gas-liquid-particulate-binder mixture is heated inside the chamber by the heated carrier gas.

In this embodiment, the outlet flow of the nozzles and the heated gas enter the evaporation chamber 823 of the evaporation section 853 from substantially the same direction. In the evaporation chamber 823, substantially all of the liquid vehicle from the droplets is evaporated thereby forming agglomerates of the particles, or the particles and the binder, the agglomerates being interspersed in a gaseous carrier stream, which is comprised of the carrier gas and the atomizing gas.

The deposition zone 831 in fluid communication with the duct 851 houses a plugged ceramic honeycomb body 830, for example, a wall-flow particulate filter or “wall-flow filter.” The deposition zone 831 has an inner diameter that is larger than the outer diameter of the ceramic honeycomb body 830. To avoid leakage of the gases carrying the ceramic powders, the ceramic honeycomb body 830 is sealed to the inner diameter of deposition zone 831, a suitable seal is, for example, an inflatable “inner tube”. A pressure gauge, labelled as “PG,” measures the difference in the pressure upstream and downstream from the particulate filter. The gas-liquid-particulate-binder mixture flows into the ceramic honeycomb body 830 thereby depositing the inorganic material of the suspension on the ceramic honeycomb body. Specifically, the agglomerates and the gaseous carrier stream pass into the honeycomb body such that the gaseous carrier stream passes through the porous walls of the honeycomb body, and the walls of the honeycomb body trap the agglomerates, wherein the agglomerates and/or aggregates thereof are deposited on or in the walls of the honeycomb body. The inorganic material binds to the ceramic honeycomb body upon post-treatment to the ceramic honeycomb body. In an embodiment, binder causes the agglomerates to adhere or stick to the walls of the honeycomb body.

Downstream from the ceramic honeycomb body 830 is an exit zone 836 defining an exit chamber 835. The flow driver 845 is downstream from the ceramic honeycomb body 830, in fluid communication with the deposition zone 831 and the exit zone 836 by way of the exit conduit 840. Non-limiting examples of flow drivers are: fan, blower, and vacuum pump. The droplets of the atomized suspension are aerosolized and dried and deposited on one or more walls of the particulate filter as agglomerates of filtration material, which is present as discrete regions of filtration material, or in some portions or some embodiments as a layer, or both, wherein the agglomerates are comprised of primary particles of inorganic material.

Flow through embodiments such as apparatus 800 is considered in a downward direction, for example, substantially parallel to the direction of gravity. In other embodiments, the apparatus may be configured such that flow is directed in a substantially upward or vertical direction.

### General Overview of Honeycomb Bodies

The ceramic articles herein comprise honeycomb bodies comprised of a porous ceramic honeycomb structure of porous walls having wall surfaces defining a plurality of inner channels.

In some embodiments, the porous ceramic walls comprise a material such as a filtration material which may comprise in some portions or some embodiments a porous inorganic layer disposed on one or more surfaces of the walls. In some embodiments, the filtration material comprises one or more inorganic materials, such as one or more ceramic or refractory materials. In some embodiments, the filtration material is disposed on the walls to provide enhanced filtration efficiency, both locally through and at the wall and globally through the honeycomb body, at least in the initial use of the honeycomb body as a filter following a clean state, or regenerated state, of the honeycomb body, for example such as before a substantial accumulation of ash and/or soot occurs inside the honeycomb body after extended use of the honeycomb body as a filter.

In one aspect, the filtration material is present in some portions or some embodiments as a layer disposed on the surface of one or more of the walls of the honeycomb structure. The layer in some embodiments is porous to allow the gas flow through the wall. In some embodiments, the layer is present as a continuous coating over at least part of the, or over the entire, surface of the one or more walls. In some embodiments of this aspect, the filtration material is flame-deposited filtration material.

In another aspect, the filtration material is present as a plurality of discrete regions of filtration material disposed on the surface of one or more of the walls of the honeycomb structure. The filtration material may partially block a portion of some of the pores of the porous walls, while still allowing gas flow through the wall. In some embodiments of this aspect, the filtration material is aerosol-deposited filtration material. In some preferred embodiments, the filtration material comprises a plurality of inorganic particle agglomerates, wherein the agglomerates are comprised of inorganic or ceramic or refractory material. In some embodiments, the agglomerates are porous, thereby allowing gas to flow through the agglomerates.

In some embodiments, a honeycomb body comprises a porous ceramic honeycomb body comprising a first end, a second end, and a plurality of walls having wall surfaces defining a plurality of inner channels. A deposited material such as a filtration material, which may be in some portions or some embodiments a porous inorganic layer, is disposed on one or more of the wall surfaces of the honeycomb body. The deposited material such as a filtration material, which may be a porous inorganic layer has a porosity as measured by mercury intrusion porosimetry, SEM, or X-ray tomography in a range of from about 20% to about 95%, or from about 25% to about 95%, or from about 30% to about 95%, or from about 40% to about 95%, or from about 45% to about 95%, or from about 50% to about 95%, or from about 55% to about 95%, or from about 60% to about 95%, or from about 65% to about 95%, or from about 70% to about 95%, or from about 75% to about 95%, or from about 80% to about 95%, or from about 85% to about 95%, from about 30% to about 95%, or from about 40% to about 95%, or from about 45% to about 95%, or from about 50% to about 95%, or from about 55% to about 95%, or from about 60% to about 95%, or from about 65% to about 95%, or from about 70% to about 95%, or from about 75% to about 95%, or from about 80% to about 95%, or from about 85% to about 95%, or from about 20% to about 90%, or from about 25% to about 90%, or from about 30% to about 90%, or from about 40% to about 90%, or from about 45% to about 90%, or from about 50% to about 90%, or from about 55% to about 90%, or from about 60% to about 90%, or from about 65% to about 90%, or from about 70% to about 90%, or from about 75% to about 90%, or from about 80% to about 90%, or from about 85% to about 90%, or from about 20% to about 85%, or from about 25% to about 85%, or from about 30% to about 85%, or from about 40% to about 85%, or from about 45% to about 85%, or from about 50% to about 85%, or from about 55% to about 85%, or from about 60% to about 85%, or from about 65% to about 85%, or from about 70% to about 85%, or from about 75% to about 85%, or from about 80% to about 85%, or from about 20% to about 80%, or from about 25% to about 80%, or from about 30% to about 80%, or from about 40% to about 80%, or from about 45% to about 80%, or from about 50% to about 80%, or from about 55% to about 80%, or from about 60% to about 80%, or from about 65% to about 80%, or from about 70% to about 80%, or from about 75% to about 80%, and the deposited material such as a filtration material, which may be a porous inorganic layer that has an average thickness of greater than or equal to 0.5 μm and less than or equal to 50 μm, or greater than or equal to 0.5 μm and less than or equal to 45 μm, greater than or equal to 0.5 μm and less than or equal to 40 μm, or greater than or equal to 0.5 μm and less than or equal to 35 μm, or greater than or equal to 0.5 μm and less than or equal to 30 μm, greater than or equal to 0.5 μm and less than or equal to 25 μm, or greater than or equal to 0.5 μm and less than or equal to 20 μm, or greater than or equal to 0.5 μm and less than or equal to 15 μm, greater than or equal to 0.5 μm and less than or equal to 10 μm. Various embodiments of honeycomb bodies and methods for forming such honeycomb bodies will be described herein with specific reference to the appended drawings.

The material in some embodiments comprises a filtration material, and in some embodiments comprises an inorganic filtration material. According to one or more embodiments, the inorganic filtration material provided herein comprises discrete regions and/or a discontinuous layer formed from the inlet end to the outlet end comprising discrete and disconnected patches of material or filtration material and binder comprised of primary particles in secondary particles or agglomerates that are substantially spherical. In one or more embodiments, the primary particles are non-spherical. In one or more embodiments, “substantially spherical” refers to agglomerate having circularity in cross section in a range of from about 0.8 to about 1 or from about 0.9 to about 1, with 1 representing a perfect circle. In one or more embodiments, 75% of the primary particles deposited on the honeycomb body have a circularity of less than 0.8. In one or more embodiments, the secondary particles or agglomerates deposited on the honeycomb body have an average circularity greater than 0.9, greater than 0.95, greater than 0.96, greater than 0.97, greater than 0.98, or greater than 0.99.

Circularity can be measured using a scanning electron microscope (SEM). The term “circularity of the cross-section (or simply circularity)” is a value expressed using the equation shown below. A circle having a circularity of 1 is a perfect circle.

Circularity=(4π×cross-sectional area)/(length of circumference of the cross-section)².

A honeycomb body of one or more embodiments may comprise a honeycomb structure and deposited material such as a filtration material disposed on one or more walls of the honeycomb structure. In some embodiments, the deposited material such as a filtration material is applied to surfaces of walls present within honeycomb structure, where the walls have surfaces that define a plurality of inner channels.

The inner channels, when present, may have various cross-sectional shapes, such as circles, ovals, triangles, squares, pentagons, hexagons, or tessellated combinations or any of these, for example, and may be arranged in any suitable geometric configuration. The inner channels, when present, may be discrete or intersecting and may extend through the honeycomb body from a first end thereof to a second end thereof, which is opposite the first end.

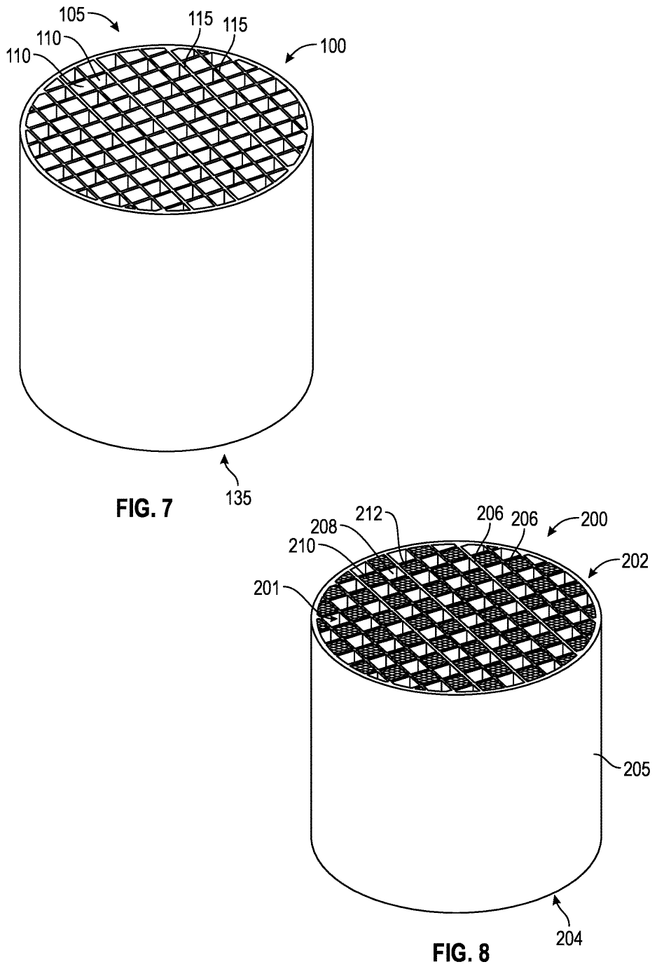

With reference now to FIG. 7, a honeycomb body 100 according to one or more embodiments shown and described herein is depicted. The honeycomb body 100 may, in embodiments, comprise a plurality of walls 115 defining a plurality of inner channels 110. The plurality of inner channels 110 and intersecting channel walls 115 extend between first end 105, which may be an inlet end, and second end 135, which may be an outlet end, of the honeycomb body. The honeycomb body may have one or more of the channels plugged on one, or both of the first end 105 and the second end 135. The pattern of plugged channels of the honeycomb body is not limited. In some embodiments, a pattern of plugged and unplugged channels at one end of the honeycomb body may be, for example, a checkerboard pattern where alternating channels of one end of the honeycomb body are plugged. In some embodiments, plugged channels at one end of the honeycomb body have corresponding unplugged channels at the other end, and unplugged channels at one end of the honeycomb body have corresponding plugged channels at the other end.

In one or more embodiments, the honeycomb body may be formed from cordierite, aluminum titanate, enstatite, mullite, forsterite, corundum (SiC), spinel, sapphirine, and periclase. In general, cordierite has a composition according to the formula Mg₂Al₄Si₅O₁₈. In some embodiments, the pore size of the ceramic material, the porosity of the ceramic material, and the pore size distribution of the ceramic material are controlled, for example by varying the particle sizes of the ceramic raw materials. In addition, pore formers can be included in ceramic batches used to form the honeycomb body.

In some embodiments, walls of the honeycomb body may have an average thickness from greater than or equal to 25 μm to less than or equal to 250 μm, such as from greater than or equal to 45 μm to less than or equal to 230 μm, greater than or equal to 65 μm to less than or equal to 210 μm, greater than or equal to 65 μm to less than or equal to 190 μm, or greater than or equal to 85 μm to less than or equal to 170 μm. The walls of the honeycomb body can be described to have a base portion comprised of a bulk portion (also referred to herein as the bulk), and surface portions (also referred to herein as the surface). The surface portion of the walls extends from a surface of a wall of the honeycomb body into the wall toward the bulk portion of the honeycomb body. The surface portion may extend from 0 (zero) to a depth of about 10 μm into the base portion of the wall of the honeycomb body. In some embodiments, the surface portion may extend about 5 μm, about 7 μm, or about 9 μm (i.e., a depth of 0 (zero)) into the base portion of the wall. The bulk portion of the honeycomb body constitutes the thickness of wall minus the surface portions. Thus, the bulk portion of the honeycomb body may be determined by the following equation:

$${t}_{total} - 2 {t}_{suτface}$$

where tₜₒₜₐₗ is the total thickness of the wall and t_{surface} is the thickness of the wall surface.

In one or more embodiments, the bulk of the honeycomb body (prior to applying any filtration material) has a bulk median pore size from greater than or equal to 7 μm to less than or equal to 25 μm, such as from greater than or equal to 12 μm to less than or equal to 22 μm, or from greater than or equal to 12 μm to less than or equal to 18 μm. For example, in some embodiments, the bulk of the honeycomb body may have bulk median pore sizes of about 10 μm, about 11 μm, about 12 μm, about 13 μm, about 14 μm, about 15 μm, about 16 μm, about 17 μm, about 18 μm, about 19 μm, or about 20 μm. Generally, pore sizes of any given material exist in a statistical distribution. Thus, the term “median pore size” or “d50” (prior to applying any filtration material) refers to a length measurement, above which the pore sizes of 50% of the pores lie and below which the pore sizes of the remaining 50% of the pores lie, based on the statistical distribution of all the pores. Pores in ceramic bodies can be manufactured by at least one of: (1) inorganic batch material particle size and size distributions; (2) furnace/heat treatment firing time and temperature schedules; (3) furnace atmosphere (e.g., low or high oxygen and/or water content), as well as; (4) pore formers, such as, for example, polymers and polymer particles, starches, wood flour, hollow inorganic particles and/or graphite/carbon particles.

In specific embodiments, the median pore size (d50) of the bulk of the honeycomb body (prior to applying any filtration material) is in a range of from 10 μm to about 16 μm, for example 13-14 μm, and the d10 refers to a length measurement, above which the pore sizes of 90% of the pores lie and below which the pore sizes of the remaining 10% of the pores lie, based on the statistical distribution of all the pores is about 7 μm. In specific embodiments, the d90 refers to a length measurement, above which the pore sizes of 10% of the pores of the bulk of the honeycomb body (prior to applying any filtration material) lie and below which the pore sizes of the remaining 90% of the pores lie, based on the statistical distribution of all the pores is about 30 μm. In specific embodiments, the mean or average diameter (D50) of the secondary particles or agglomerates is greater than 0.5 microns and less than 5 microns, d90 greater than 1 microns and less than 5 microns and d10 greater than 0.3 microns and less than 2 microns, for example about 2 microns. In specific embodiments, it has been determined that when the agglomerate mean size D50 and the mean wall pore size of the bulk honeycomb body d50 is such that there is a ratio of agglomerate mean size D50 to mean wall pore size of the bulk honeycomb body d50 is in a range of from 5:1 to 16:1, excellent filtration efficiency results and low pressure drop results are achieved. In more specific embodiments, a ratio of agglomerate mean size D50 to mean wall pore size of the bulk of honeycomb body d50 (prior to applying any filtration material) is in a range of from 6:1 to 16:1, 7:1 to 16:1, 8:1 to 16:1, 9:1 to 16:1, 10:1 to 16:1, 11:1 to 16:1 or 12:1 to 6:1 provide excellent filtration efficiency results and low pressure drop results.

In some embodiments, the bulk of the honeycomb body may have bulk porosities, not counting a coating, of from greater than or equal to 50% to less than or equal to 75% as measured by mercury intrusion porosimetry. Other methods for measuring porosity include scanning electron microscopy (SEM) and X-ray tomography, these two methods in particular are valuable for measuring surface porosity and bulk porosity independent from one another. In one or more embodiments, the bulk porosity of the honeycomb body may be in a range of from about 50% to about 75%, in a range of from about 50% to about 70%, in a range of from about 50% to about 65%, in a range of from about 50% to about 60%, in a range of from about 50% to about 58%, in a range of from about 50% to about 56%, or in a range of from about 50% to about 54%, for example.

In one or more embodiments, the surface portion of the honeycomb body has a surface median pore size from greater than or equal to 7 μm to less than or equal to 20 μm, such as from greater than or equal to 8 μm to less than or equal to 15 μm, or from greater than or equal to 10 μm to less than or equal to 14 μm. For example, in some embodiments, the surface of the honeycomb body may have surface median pore sizes of about 8 μm, about 9 μm, about 10 μm, about 11 μm, about 12 μm, about 13 μm, about 14 μm, or about 15 μm.

In some embodiments, the surface of the honeycomb body may have surface porosities, prior to application of a filtration material deposit, of from greater than or equal to 35% to less than or equal to 75% as measured by mercury intrusion porosimetry, SEM, or X-ray tomography. In one or more embodiments, the surface porosity of the honeycomb body may be less than 65%, such as less than 60%, less than 55%, less than 50%, less than 48%, less than 46%, less than 44%, less than 42%, less than 40%, less than 48%, or less than 36% for example.

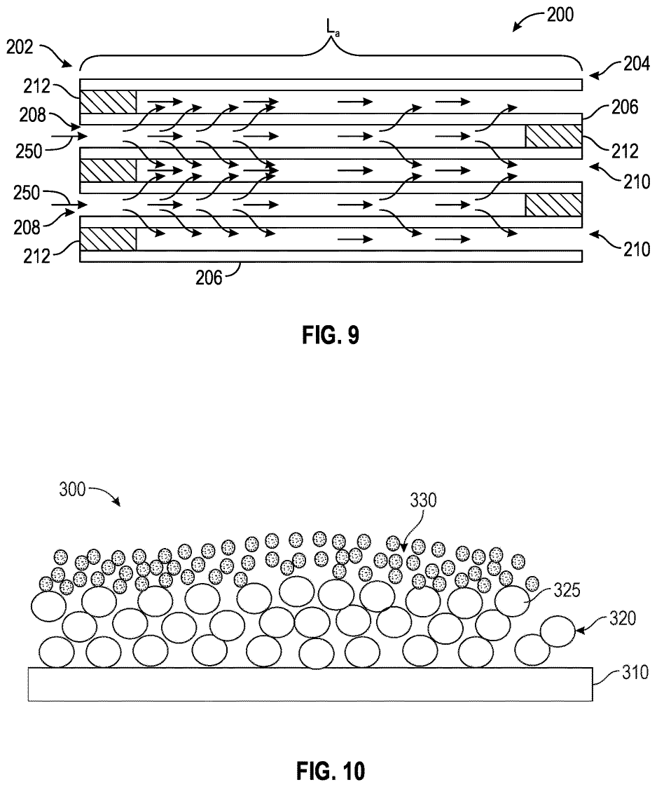

Referring now to FIGS. 8 and 9, a honeycomb body in the form of a particulate filter 200 is schematically depicted. The particulate filter 200 may be used as a wall-flow filter to filter particulate matter from an exhaust gas stream 250, such as an exhaust gas stream emitted from a gasoline engine, in which case the particulate filter 200 is a gasoline particulate filter. The particulate filter 200 generally comprises a honeycomb body having a plurality of channels 201 or cells which extend between an inlet end 202 and an outlet end 204, defining an overall length La (shown in FIG. 9). The channels 201 of the particulate filter 200 are formed by, and at least partially defined by a plurality of intersecting channel walls 206 that extend from the inlet end 202 to the outlet end 204. The particulate filter 200 may also include a skin layer 205 surrounding the plurality of channels 201. This skin layer 205 may be extruded during the formation of the channel walls 206 or formed in later processing as an after-applied skin layer, such as by applying a skinning cement to the outer peripheral portion of the channels.

An axial cross section of the particulate filter 200 of FIG. 8 is shown in FIG. 9. In some embodiments, certain channels are designated as inlet channels 208 and certain other channels are designated as outlet channels 210. In some embodiments of the particulate filter 200, at least a first set of channels may be plugged with plugs 212. Generally, the plugs 212 are arranged proximate the ends (i.e., the inlet end or the outlet end) of the channels 201. The plugs are generally arranged in a pre-defined pattern, such as in the checkerboard pattern shown in FIG. 8, with every other channel being plugged at an end. The inlet channels 208 may be plugged at or near the outlet end 204, and the outlet channels 210 may be plugged at or near the inlet end 202 on channels not corresponding to the inlet channels, as depicted in FIG. 9. Accordingly, each cell may be plugged at or near one end of the particulate filter only.

While FIG. 8 generally depicts a checkerboard plugging pattern, it should be understood that alternative plugging patterns may be used in the porous ceramic honeycomb article. In the embodiments described herein, the particulate filter 200 may be formed with a channel density of up to about 600 channels per square inch (cpsi). For example, in some embodiments, the particulate filter 100 may have a channel density in a range from about 100 cpsi to about 600 cpsi. In some other embodiments, the particulate filter 100 may have a channel density in a range from about 100 cpsi to about 400 cpsi or even from about 200 cpsi to about 300 cpsi.

In the embodiments described herein, the channel walls 206 of the particulate filter 200 may have a thickness of greater than about 4 mils (101.6 microns). For example, in some embodiments, the thickness of the channel walls 206 may be in a range from about 4 mils up to about 30 mils (762 microns). In some other embodiments, the thickness of the channel walls 206 may be in a range from about 7 mils (177.8 microns) to about 20 mils (508 microns).

In some embodiments of the particulate filter 200 described herein the channel walls 206 of the particulate filter 200 may have a bare open porosity (i.e., the porosity before any coating is applied to the honeycomb body) % P≥35% prior to the application of any coating to the particulate filter 200. In some embodiments the bare open porosity of the channel walls 206 may be such that 40%≤P≤75%. In other embodiments, the bare open porosity of the channel walls 206 may be such that 45%≤% P≤75%, 50%≤% P≤75%, 55%≤% P≤75%, 60%≤% P≤75%, 45%≤% P≤70%, 50%≤% P≤70%, 55%≤% P≤70%, or 60%≤% P≤70%.

Further, in some embodiments, the channel walls 206 of the particulate filter 200 are formed such that the pore distribution in the channel walls 206 has a median pore size of ≤30 microns prior to the application of any coatings (i.e., bare). For example, in some embodiments, the median pore size may be ≥8 microns and less than or ≤30 microns. In other embodiments, the median pore size may be ≥10 microns and less than or ≤30 microns. In other embodiments, the median pore size may be ≥10 microns and less than or ≤25 microns. In some embodiments, particulate filters produced with a median pore size greater than about 30 microns have reduced filtration efficiency while with particulate filters produced with a median pore size less than about 8 microns may be difficult to infiltrate the pores with a washcoat containing a catalyst. Accordingly, in some embodiments, it is desirable to maintain the median pore size of the channel wall in a range of from about 8 microns to about 30 microns, for example, in a range of rom 10 microns to about 20 microns.

In one or more embodiments described herein, the honeycomb body of the particulate filter 200 is formed from a metal or ceramic material such as, for example, cordierite, silicon carbide, aluminum oxide, aluminum titanate or any other ceramic material suitable for use in elevated temperature particulate filtration applications. For example, the particulate filter 200 may be formed from cordierite by mixing a batch of ceramic precursor materials which may include constituent materials suitable for producing a ceramic article which predominately comprises a cordierite crystalline phase. In general, the constituent materials suitable for cordierite formation include a combination of inorganic components including talc, a silica-forming source, and an alumina-forming source. The batch composition may additionally comprise clay, such as, for example, kaolin clay. The cordierite precursor batch composition may also contain organic components, such as organic pore formers, which are added to the batch mixture to achieve the desired pore size distribution. For example, the batch composition may comprise a starch which is suitable for use as a pore former and/or other processing aids. Alternatively, the constituent materials may comprise one or more cordierite powders suitable for forming a sintered cordierite honeycomb structure upon firing as well as an organic pore former material.

The batch composition may additionally comprise one or more processing aids such as, for example, a binder and a liquid vehicle, such as water or a suitable solvent. The processing aids are added to the batch mixture to plasticize the batch mixture and to generally improve processing, reduce the drying time, reduce cracking upon firing, and/or aid in producing the desired properties in the honeycomb body. For example, the binder can include an organic binder. Suitable organic binders include water soluble cellulose ether binders such as methylcellulose, hydroxypropyl methylcellulose, methylcellulose derivatives, hydroxyethyl acrylate, polyvinylalcohol, and/or any combinations thereof. Incorporation of the organic binder into the plasticized batch composition allows the plasticized batch composition to be readily extruded. In some embodiments, the batch composition may include one or more optional forming or processing aids such as, for example, a lubricant which assists in the extrusion of the plasticized batch mixture. Exemplary lubricants can include tall oil, sodium stearate or other suitable lubricants.

After the batch of ceramic precursor materials is mixed with the appropriate processing aids, the batch of ceramic precursor materials is extruded and dried to form a green honeycomb body comprising an inlet end and an outlet end with a plurality of channel walls extending between the inlet end and the outlet end. Thereafter, the green honeycomb body is fired according to a firing schedule suitable for producing a fired honeycomb body. At least a first set of the channels of the fired honeycomb body are then plugged in a predefined plugging pattern with a ceramic plugging composition and the fired honeycomb body is again fired to ceram the plugs and secure the plugs in the channels.

In various embodiments the honeycomb body is configured to filter particulate matter from a gas stream, for example, an exhaust gas stream from a gasoline engine. Accordingly, the median pore size, porosity, geometry and other design aspects of both the bulk and the surface of the honeycomb body are selected taking into account these filtration requirements of the honeycomb body. As an example, and as shown in the embodiment of FIG. 10, which depicts a simplified schematic of a wall 310 of the honeycomb body 300, which can be in the form of the particulate filter as shown in FIGS. 8 and 9, and which has pores (not shown). Filtration material deposits 320 are disposed thereon, and/or therein, and/or both on and in the wall 310, which in some embodiments are sintered or otherwise bonded by heat treatment to the wall. The filtration material deposits 320 comprise particles 325 that are deposited on and/or in the wall 310 of the honeycomb body 300 and help prevent particulate matter from exiting the honeycomb body along with the gas stream 330, such as, for example, soot and/or ash, and to help prevent the particulate matter from clogging the base portion of the walls 310 of the honeycomb body 300. In this way, and according to embodiments, the filtration material deposits 320 can serve as the primary filtration component while the base portion of the honeycomb body can be configured to otherwise minimize pressure drop for example as compared to honeycomb bodies without such filtration material deposits. The filtration material deposits are delivered by the aerosol deposition methods disclosed herein.

As mentioned above, the material, which in some portions or some embodiments may be an inorganic layer, on walls of the honeycomb body is very thin compared to thickness of the base portion of the walls of the honeycomb body. As will be discussed in further detail below, the material, which may be an inorganic layer, on the honeycomb body can be formed by methods that permit the deposited material to be applied to surfaces of walls of the honeycomb body in very thin applications or in some portions, layers. In embodiments, the average thickness of the material, which may be deposit regions or an inorganic layer, on the base portion of the walls of the honeycomb body is greater than or equal to 0.5 μm and less than or equal to 50 μm, or greater than or equal to 0.5 μm and less than or equal to 45 μm, greater than or equal to 0.5 μm and less than or equal to 40 μm, or greater than or equal to 0.5 μm and less than or equal to 35 μm, or greater than or equal to 0.5 μm and less than or equal to 30 μm, greater than or equal to 0.5 μm and less than or equal to 25 μm, or greater than or equal to 0.5 μm and less than or equal to 20 μm, or greater than or equal to 0.5 μm and less than or equal to 15 μm, greater than or equal to 0.5 μm and less than or equal to 10 μm.

As discussed above, the deposited material, which may in some portions or some embodiments be an inorganic layer, can be applied to the walls of the honeycomb body by methods that permit the inorganic material, which may be an inorganic layer, to have a small median pore size. This small median pore size allows the material, which may be an inorganic layer, to filter a high percentage of particulate and prevents particulate from penetrating honeycomb and settling into the pores of the honeycomb. The small median pore size of material, which may be an inorganic layer, according to embodiments increases the filtration efficiency of the honeycomb body. In one or more embodiments, the material, which may be an inorganic layer, on the walls of the honeycomb body has a median pore size from greater than or equal to 0.1 μm to less than or equal to 5 μm, such as from greater than or equal to 0.5 μm to less than or equal to 4 μm, or from greater than or equal to 0.6 μm to less than or equal to 3 μm. For example, in some embodiments, the material, which may be an inorganic layer, on the walls of the honeycomb body may have median pore sizes of about 0.5 μm, about 0.6 μm, about 0.7 μm, about 0.8 μm, about 0.9 μm, about 1 μm, about 2 μm, about 3 μm, or about 4 μm.

Although the deposited material, which may be an inorganic layer, on the walls of the honeycomb body may, in some embodiments, cover substantially 100% of the wall surfaces defining inner channels of the honeycomb body, in other embodiments, the material, which may be an inorganic layer, on the walls of the honeycomb body covers less than substantially 100% of the wall surfaces defining inner channels of the honeycomb body. For instance, in one or more embodiments, the deposited material, which may be an inorganic layer, on the walls of the honeycomb body covers at least 70% of the wall surfaces defining inner channels of the honeycomb body, covers at least 75% of the wall surfaces defining inner channels of the honeycomb body, covers at least 80% of the wall surfaces defining inner channels of the honeycomb body, covers at least 85% of the wall surfaces defining inner channels of the honeycomb body, covers at least 90% of the wall surfaces defining inner channels of the honeycomb body, or covers at least 85% of the wall surfaces defining inner channels of the honeycomb body.

As described above with reference to FIGS. 7 and 8, the honeycomb body can have a first end and second end. The first end and the second end are separated by an axial length. In some embodiments, the filtration material deposits on the walls of the honeycomb body may extend the entire axial length of the honeycomb body (i.e., extends along 100% of the axial length). However, in other embodiments, the material, which may be an inorganic layer, on the walls of the honeycomb body extends along at least 60% of the axial length, such as extends along at least 65% of the axial length, extends along at least 70% of the axial length, extends along at least 75% of the axial length, extends along at least 80% of the axial length, extends along at least 85% of the axial length, extends along at least 90% of the axial length, or extends along at least 95% of the axial length.

In embodiments, the material, which may in some portions or some embodiments be an inorganic layer, on the walls of the honeycomb body extends from the first end of the honeycomb body to the second end of the honeycomb body. In some embodiments, the material, which may be an inorganic layer, on the walls of the honeycomb body extends the entire distance from the first surface of the honeycomb body to the second surface of the honeycomb body (i.e., extends along 100% of a distance from the first surface of the honeycomb body to the second surface of the honeycomb body). However, in one or more embodiments, the layer or material, which may be an inorganic layer, on the walls of the honeycomb body extends along 60% of a distance between the first surface of the honeycomb body and the second surface of the honeycomb body, such as extends along 65% of a distance between the first surface of the honeycomb body and the second surface of the honeycomb body, extends along 70% of a distance between the first surface of the honeycomb body and the second surface of the honeycomb body, extends along 75% of a distance between the first surface of the honeycomb body and the second surface of the honeycomb body, extends along 80% of a distance between the first surface of the honeycomb body and the second surface of the honeycomb body, extends along 85% of a distance between the first surface of the honeycomb body and the second surface of the honeycomb body, extends along 90% of a distance between the first surface of the honeycomb body and the second surface of the honeycomb body, or extends along 95% of a distance between the first surface of the honeycomb body and the second surface of the honeycomb body.

The selection of a honeycomb body having a low pressure drop in combination with the low thickness and porosity of the filtration material on the honeycomb body according to embodiments allows a honeycomb body of embodiments to have a low initial pressure drop when compared to other honeycomb bodies. In embodiments, the loading of the layer is in a range of from 0.3 to 30 g/L on the honeycomb body, such as in a range of from 1 to 30 g/L on the honeycomb body, or in a range of from 3 to 30 g/L on the honeycomb body. In other embodiments, the loading of the layer is in a range of from 1 to 20 g/L on the honeycomb body, such as in a range of from 1 to 10 g/L on the honeycomb body. In specific embodiments, the loading of the layer is in a range of from 1 to 9 g/L, 1 to 8 g/L, 1 to 7 g/L, 1 to 8 g/L, 1 to 5 g/L, 1 to 4 g/L, 1 to 3 g/L, 2 to 10 g/L, 2 to 9 g/L, 2 to 8 g/L, 2 to 7 g/L, 2 to 6 g/L, 2 to 5 g/L, 2 to 4 g/L, 3 to 10 g/L, 3 to 9 g/L, 3 to 8 g/L, 3 to 7 g/L, 3 to 6 g/L, 3 to 5 g/L, 4 to 10 g/L, 4 to 9 g/L 4 to 8 g/L, 4 to 7 g/L, or 4 to 6 g/L on the honeycomb body. In some embodiments, the increase in pressure drop across the honeycomb due to the application of the porous layer across is less than 20% of the uncoated honeycomb. In other embodiments that increase can be less than or equal to 9%, or less than or equal to 8%. In other embodiments, the pressure drop increase across the honeycomb body is less than or equal to 7%, such as less than or equal to 6%. In still other embodiments, the pressure drop increase across the honeycomb body is less than or equal to 5%, such as less than or equal to 4%, or less than or equal to 3%.

Without being bound to any particular theory, it is believed that small pore sizes in the filtration material deposits on the walls of the honeycomb body allow the honeycomb body to have good filtration efficiency even before ash or soot build-up occurs in the honeycomb body. The filtration efficiency of honeycomb bodies is measured herein using the protocol outlined in Tandon et al., 65 CHEMICAL ENGINEERING SCIENCE 4751-60 (2010). As used herein, the initial filtration efficiency of a honeycomb body refers to a new or regenerated honeycomb body that does not comprise any measurable soot or ash loading. In embodiments, the initial filtration efficiency (i.e., clean filtration efficiency) of the honeycomb body is greater than or equal to 70%, such as greater than or equal to 80%, or greater than or equal to 85%. In yet other embodiments, the initial filtration efficiency of the honeycomb body is greater than 90%, such as greater than or equal to 93%, or greater than or equal to 95%, or greater than or equal to 98%.

The material, which is in some embodiments an inorganic filtration material, on the walls of the honeycomb body according to embodiments is thin and has a porosity, and in some embodiments also has good chemical durability and physical stability. The chemical durability and physical stability of the filtration material deposits on the honeycomb body can be determined, in embodiments, by subjecting the honeycomb body to test cycles comprising burn out cycles and an aging test and measuring the initial filtration efficiency before and after the test cycles. For instance, one exemplary method for measuring the chemical durability and the physical stability of the honeycomb body comprises measuring the initial filtration efficiency of a honeycomb body; loading soot onto the honeycomb body under simulated operating conditions; burning out the built up soot at about 650° C.; subjecting the honeycomb body to an aging test at 1050° C. and 10% humidity for 12 hours; and measuring the filtration efficiency of the honeycomb body. Multiple soot build up and burnout cycles may be conducted. A small change in filtration efficiency (ΔFE) from before the test cycles to after the test cycles indicates better chemical durability and physical stability of the filtration material deposits on the honeycomb body. In some embodiments, the ΔFE is less than or equal to 5%, such as less than or equal to 4%, or less than or equal to 3%. In other embodiments, the ΔFE is less than or equal to 2%, or less than or equal to 1%.

In some embodiments, the filtration material deposits on the walls of the honeycomb body may be comprised of one or a mixture of ceramic components, such as, for example, ceramic components selected from the group consisting of SiO₂, Al₂O₃, MgO, ZrO₂, CaO, TiO₂, CeO₂, Na₂O, Pt, Pd, Ag, Cu, Fe, Ni, and mixtures thereof. Thus, the filtration material deposits on the walls of the honeycomb body may comprise an oxide ceramic. As discussed in more detail below, the method for forming the filtration material deposits on the honeycomb body according to embodiments can allow for customization of the filtration material composition for a given application. This may be beneficial because the ceramic components may be combined to match, for example, the physical properties—such as, for example coefficient of thermal expansion (CTE) and Young's modulus, etc.—of the honeycomb body, which can improve the physical stability of the honeycomb body. In some embodiments, the filtration material deposits on the walls of the honeycomb body may comprise cordierite, aluminum titanate, enstatite, mullite, forsterite, corundum (SiC), spinel, sapphirine, and periclase.

In some embodiments, the composition of the filtration material deposits on the walls of the honeycomb body is the same as the composition of the honeycomb body. However, in other embodiments, the composition of the filtration material is different from the composition of the walls of the matrix of the honeycomb body.

The properties of the filtration material deposits and, in turn, the honeycomb body overall are attributable to the ability of applying a sparse or thin porous filtration material having small median pore sizes relative to the host honeycomb body.

In some embodiments, the method of forming a honeycomb body comprises forming or obtaining a mixture or a suspension that comprises a ceramic precursor material and a solvent. The ceramic precursor material of the filtration material precursor comprises ceramic materials that serve as a source of, for example, SiO₂, Al₂O₃, TiO₂, MgO, ZrO₂, CaO, CeO₂, Na₂O, Pt, Pd, Ag, Cu, Fe, Ni, and the like.

In one or more embodiments, the suspension is atomized with an atomizing gas to form liquid-particulate-binder droplets comprised of the liquid vehicle, the binder material, and the particles, is directed to a honeycomb body, Agglomerates formed upon removal or evaporation of the liquid vehicle are then deposited on the honeycomb body. In some embodiments, the honeycomb body may have one or more of the channels plugged on one end, such as, for example, the first end of the honeycomb body during the deposition of the aerosol to the honeycomb body. The plugged channels may, in some embodiments, be removed after deposition of the aerosol. But, in other embodiments, the channels may remain plugged even after deposition of the aerosol. The pattern of plugging channels of the honeycomb body is not limited, and in some embodiments all the channels of the honeycomb body may be plugged at one end. In other embodiments, only a portion of the channels of the honeycomb body may be plugged at one end. In such embodiments, the pattern of plugged and unplugged channels at one end of the honeycomb body is not limited and may be, for example, a checkerboard pattern where alternating channels of one end of the honeycomb body are plugged. By plugging all or a portion of the channels at one end of the honeycomb body during deposition of the aerosol, the aerosol may be evenly distributed within the channels of the honeycomb body.

According to one or more embodiments, binders with high temperature (e.g., greater than 400° C.) resistance are included in the agglomerates and filtration material deposits to enhance integrity of the agglomerates and deposits even at high temperatures encountered in exhaust gas emissions treatment systems. In specific embodiments, a filtration material can comprise about 5 to 25 wt % alkoxy-siloxane resin. The microstructure of the filtration material deposits was similar to the as-deposited morphology after the various tests described below. Inorganic binders could also be used in one or more embodiments. The filtration efficiency of both samples was higher than 60% after the high flow blowing test, a high flow test at 850 Nm³/h. The tests demonstrated that the binders, including organic and inorganic binders, caused the primary particles to bind together to form secondary particles (also called agglomerates), which were bound to the filter walls, even when exposed to high temperatures encountered in engine exhaust gas streams. According to one or more embodiments, other inorganic and organic binders such as silicate, phosphate (e.g. AlPO₄, AlH₂(PO₄)₃), sol (e.g. mSiO₂·nH₂O, Al(OH)ₓ·(H₂O)₆₋ₓ) and alkoxides, could also be utilized, for example to increase mechanical strength by an appropriate curing process.

### Plugged Honeycomb Bodies Comprising Inorganic Material

Embodiments of the disclosure pertain to plugged honeycomb bodies comprising porous walls and inorganic material deposited on or in or both on and in the porous walls, which provide a filtration article configured to filter particulate from an exhaust gas stream. In specific embodiments, the filtration article comprises a gasoline particulate filters (GPF) used to remove particulates from gasoline engine exhaust gases. Exhaust gas to be filtered enters inlet cells and passes through the cell walls to exit the filter via outlet channels, with the particulates being trapped on or within the inlet cell walls as the gas traverses and then exits the filter. According to one or more embodiments, porous walls of the filtration article having inorganic material deposited on or in or both on and in the porous walls provide improved filtration efficiency and excellent durability, including durability when exposed to water.

In one or more embodiments the inorganic material comprises particulate or primary particles of inorganic material (e.g. alumina), particulate-binder agglomerates (referred to as “agglomerates”) comprised of the particles and the binder, and aggregates of particulate-binder agglomerates. In one or more embodiments, the “particulate” or “primary particle” refers to the smallest discrete mass of inorganic material. In one or more embodiments, “agglomerate” refers to a mass of primary particles or particulate and binder, wherein the primary particles or particulate are held together by the binder. In one or more embodiments, “aggregates of particulate-binder agglomerates” or “aggregates of primary particle-binder agglomerates” (referred to as “aggregates”) refers to a clustered mass of individual particulate-binder agglomerates or primary particle-binder agglomerates, which are held together by the binder. In one or more embodiments, some of the aggregates and individual, for example, non-aggregated, agglomerates are deposited onto the porous walls of the honeycomb filter body. In one or more embodiments, at least a portion of the primary particles or the particulate are present in, on or both in and on the porous walls as discrete masses that are not part of agglomerate or aggregate. In one or more embodiments, at least a portion of the particulate-binder agglomerates or the primary particle-binder agglomerates are present in, on or in and on the porous walls as discrete masses that are not part of an aggregate.

In one or more embodiments, the inorganic material in or on or in and one the porous walls of the filtration article in the form of a plugged honeycomb body is present “clusters” or “chains” of agglomerates and/or aggregates. In some embodiments, the cluster or chains provide an inorganic material morphology that is one or more of finger-shaped, fibril-shaped, or sponge-like, such as for example, a morphology resembling a sea wool sponge.

As discussed herein, according to embodiments, the inorganic material is formed from a suspension comprised of nanoparticles (e.g., inorganic particles, ceramic particles, refractory particles, alumina particles, etc.), binder (e.g., a silicon-containing binder and/or an aqueous binder, and liquid vehicle (e.g., an alcohol or water). The suspension is delivered to a nozzle which sprays droplets of the suspension with a gas flow assist. The liquid vehicle is evaporated from the droplets to form spherical agglomerates of the nanoparticles. The binder serves as one or more of an agglomerate promoter, an aggregate promoter, a chain promoter and a cluster promoter. Some spherical agglomerates are conveyed to the porous ceramic walls and lodge either on the surface of the porous ceramic walls (on, in, or over surface pores present on the walls), or in pores inside the porous ceramic walls (below the surface of the porous ceramic walls), or into contact with other previously deposited agglomerates which are disposed either in or on the porous ceramic walls, so as to form aggregates of spherical agglomerates therein, or thereon. Other spherical agglomerates come into contact with still other spherical agglomerates while being conveyed toward the honeycomb filter body so as to form aggregates of spherical agglomerates, wherein the aggregates are then conveyed toward the porous ceramic walls and the aggregates then lodge either on the surface of the porous ceramic walls (on, in, or over surface pores present on the walls), or in pores inside the porous ceramic walls (below the surface of the porous ceramic walls), or into contact with other previously deposited agglomerates or aggregates which are disposed either in or on the porous ceramic walls, so as to form aggregates of spherical agglomerates therein, or thereon.

Thus, according to one or more embodiments, the inorganic deposits are comprised of individual agglomerates of nanoparticles (e.g., spherical agglomerates of nanoparticles), aggregates of agglomerates, and/or porous clusters or chains of aggregates of spherical agglomerates, wherein some clusters or chains are disposed within pores in or below the surface of the porous ceramic wall, and/or wherein some clusters are disposed on the surface of the porous ceramic wall. In some embodiments, some of the porous clusters are porous clusters or cluster islands comprising exposed aggregates of agglomerates (e.g., spherical agglomerates). In some embodiments, the porous clusters or cluster islands comprise one or more chains of two or agglomerates, each chain extending in a substantially outward direction from the porous ceramic wall. In some embodiments, a plurality of the outwardly extending chains collectively provides a morphology resembling a member of the group consisting of fingers, tufts, sponges (e.g., a sea wool sponge) and fans. In some embodiments, at least one chain includes a free end of the chain projecting above the surface of the porous ceramic wall. In some embodiments, the inorganic material on the honeycomb body is present as inorganic deposits comprising a network of aggregated spherical agglomerates of inorganic material particles.

In embodiments, the loading of the inorganic material present on the honeycomb body in a range of from 0.3 to 30 g/L on the honeycomb body, such as in a range of from 1 to 30 g/L on the honeycomb body, or in a range of from 3 to 30 g/L on the honeycomb body. In other embodiments, the loading of the inorganic material is in a range of from 1 to 20 g/L on the honeycomb body, such as in a range of from 1 to 10 g/L on the honeycomb body. In specific embodiments, the loading of the inorganic material is in a range of from 1 to 9 g/L, 1 to 8 g/L, 1 to 7 g/L, 1 to 8 g/L, 1 to 5 g/L, 1 to 4 g/L, 1 to 3 g/L, 2 to 10 g/L, 2 to 9 g/L, 2 to 8 g/L, 2 to 7 g/L, 2 to 6 g/L, 2 to 5 g/L, 2 to 4 g/L, 3 to 10 g/L, 3 to 9 g/L, 3 to 8 g/L, 3 to 7 g/L, 3 to 6 g/L, 3 to 5 g/L, 4 to 10 g/L, 4 to 9 g/L 4 to 8 g/L, 4 to 7 g/L, or 4 to 6 g/L on the honeycomb body. Loading of the inorganic material is weight of added material in grams divided by the geometric part volume in liters. The geometric part volume is based on outer dimensions of the honeycomb filter body (or plugged honeycomb body).

In one or more embodiments, the particles of the inorganic material have a surface area in a range of from 5 m²/g to 15 m²/g, 5 m²/g to 14 m²/g, 5 m²/g to 13 m²/g, 5 m²/g to 12 m²/g, 5 m²/g to 12 m²/g, or 5 m²/g to 10 m²/g.

In one or more embodiments the inorganic material deposits on the honeycomb body are free from rare earth oxides such as ceria, lanthana and yttria. In one or more embodiments the inorganic material is free from catalyst, for example, an oxidation catalyst such as a platinum group metal (e.g., platinum, palladium and rhodium) or a selective catalytic reduction catalyst such as a copper, a nickel or an iron promoted molecular sieve (e.g., a zeolite).

In one or more embodiments, prior to heat treatment of the honeycomb body comprising inorganic material on or in or on and in the porous wall, the honeycomb body further comprises a water soluble binder, for example a water soluble silicon-containing binder, a water soluble silicate binder, a water soluble aluminate binder. In one or more embodiments, the binder is present in a range of from 5 wt % to 40 wt %, 5 wt % to 35 wt %, 5 wt % to 30 wt %, 5 wt % to 25 wt %, 5 wt % to 20 wt %, 5 wt % to 15 wt % or 5 wt % to 10 wt % based on the weight of the organic material on the honeycomb body. In one or more embodiments, the binder is silicon-containing. In one or more embodiments, the silicon-containing binder is a silicone resin, or a siloxane, or an alkoxysiloxane, or a silicate. In one or more embodiments, the silicon-containing binder is comprised of an inorganic component and an organic component. In one or more embodiments, the silicon-containing binder transitions to silica upon application of heat. In one or more embodiments, the silicon-containing binder is comprised of an inorganic component and an organic component, and wherein upon application of heat the organic component is driven off and the inorganic component transitions to silica.

### EXAMPLES

Embodiments will be further understood by the following non-limiting examples.

Wall-flow filters. The diameter and length of the wall-flow filter substrates used in the examples were: 4.252 inches (10.8 cm) and 4.724 inches (12 cm), respectively. The CPSI and wall thickness were 200 and 8 mils, respectively. The bulk median pore size was ˜13 microns.

Raw Materials. Unless specified otherwise in the examples, the following raw materials were used. Inorganic material being deposited was alumina. Atomizing gas was air, and carrier gas was air. Liquid vehicles and particle dispersants were varied.

Alumina sold under tradename AKP-53 was supplied from Sumitomo. The alumina particles had: mean size of primary alumina particle of 0.17 μm, and BET surface area of 13.7 m²/g.

Liquid vehicles were selected from one or more materials in Table 1.

TABLE 1
Properties of liquid vehicles

| | | | | Surface | |
|---|---|---|---|---|---|
| | MW | Boiling | | tension | Viscosity |
| | (g/mol) | (° C.) | Polarity | (N/m) | (cP) |
| Ethanol | 46.06 | 78.37 | polar | 0.022 | 1.095 |
| Methanol | 34.04 | 64.7 | polar | 0.022 | 0.56 |
| Acetone | 58.08 | 56 | polar | 0.024 | 0.316 |
| Water | 18.02 | 100 | polar | 0.072 | 0.89 |

Reference 1: https://www.engineeringtoolbox.com/surface-tension-d_962.html
Reference 2: https://www.engineeringtoolbox.com/absolute-viscosity-liquids-d_1259.html
Reference 3: PubChem (National Library of Medicine)

Particle dispersants are identified in the examples.

All suspensions comprised: 11% by weight alumina, 87% liquid vehicle, and 2% particle dispersant. In the examples, binder was not used.

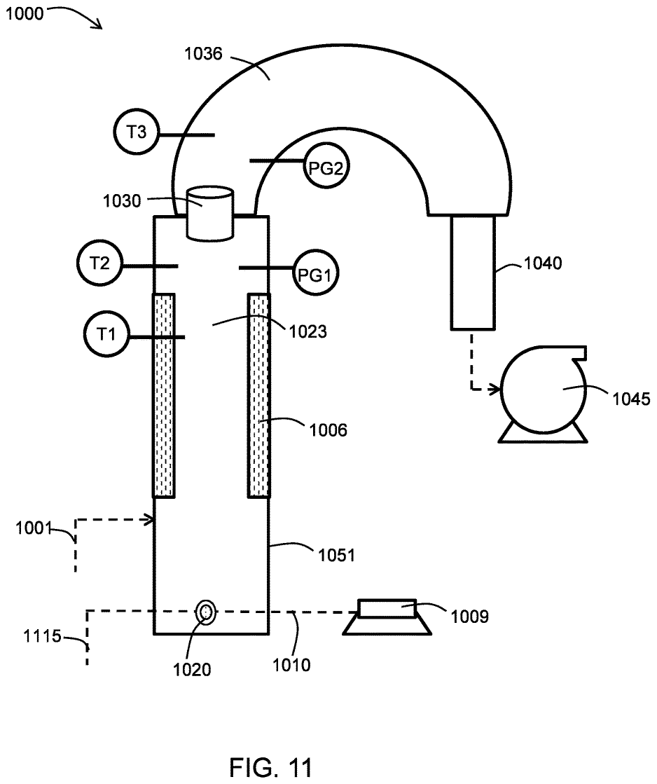

Coater. All the examples were prepared by a co-flow aerosol deposition system in accordance with FIG. 11. The apparatus 1000 comprised a duct 1051, a syringe pump 1009, an exit zone 1036, an exit conduit 1040, and a blower 1045. A substrate 1030 was positioned at one end of the duct 1051. The duct 1051 defined an evaporation chamber 1023. The syringe pump 1009 supplied a suspension 1010 to nozzle 1020. Atomizing gas, namely, air, was supplied by conduit 1115. Carrier gas, namely air, was supplied by conduit 1001. Thermocouples T1, T2, and T3 were positioned in the apparatus. Pressure gauges PG1 and PG2 were positioned upstream and downstream of the substrate 1030. A SU2A-SS spray nozzle from Spraying Systems Co. was used on the system as the nozzle 1020. For spray coating, the suspension 1010 was supplied to the nozzle 1020 with a syringe powered by a syringe pump 1009. The atomizing air 1115 for the nozzle 1020 was set at 78 psi for the experiments. The total flow rate through the chamber was controlled with the blower 1045. The blower 1045 was operated at 25 Hz for the experiments. Tape heaters and in-line gas heaters were used as heaters 1006 for the chamber. The temperature at the downstream of the coating chamber was kept at 60° C. throughout the experiments.

The flow conditions are listed in Table 2.

TABLE 2
Flow Conditions

| | |
|---|---|
| Suspension flow rate (ml/min) | 5 |
| Atomizing gas | Air pressure |
| | ~70 psi |
| Total carrier | blower |
| | frequency of |
| | 25 Hz |

Volume-based particle diameters were measured by analysis of SEM images. Diameter values were obtained by measuring sizes of agglomerates from SEM images. Reported values are volume-weighted averages.

According to one or more embodiments, a honeycomb filter body comprising filtration material deposits, which were inorganic deposits, disposed within the honeycomb filter body to create a filtration article is characterized according to one or more of the following tests.

### FILTRATION EFFICIENCY (FE) by Filtration Performance

The filtration efficiency performance of the deposited inorganic material disposed within the honeycomb filter bodies was evaluated using a filtration test by filtration performance.

The filtration efficiency (in percent %) is calculated as:

$$FE = ( 1 - \frac{{c}_{outlet}}{{c}_{inlet}} ) * 100 ,$$

where C is probing particle concentration on the outlet and inlet side of the part, respectively.

Two particle counter units (Lighthouse 2016, USA) are used simultaneously at upstream and downstream positions with respect to the article at the underfloor position of a dilution chamber. Probing particles of a Di-Ethyl-Hexyl-Sebacat (DEHS) aerosol are generated using an ATM 221 aerosol generator. The flow is driven by a blower which carries the probing particles through the tunnel and eventually into the wall flow filter parts. When the concentration at upstream of GPF reaches a stable state, the two particle counters reset to begin counting for 60 seconds and filtration efficiency (FE) was calculated based on the differential of total particle count of 0.3 μm and above. The pressure drop (dP) measured by pressure gauges located upstream and downstream from the article is also recorded at a fixed flow of 51 Nm³/hr.

Pre-Test Canning. During pre-test canning, an article is wrapped in a ceramic fiber mat material and then placed into a metal can. The article, mat and can assembly are heated in an oven to 650° C. and held at 650° C. for a duration. The mat expands to help hold the article in place within the can. This process is referred to as mat popping as the mat expands, it “pops” inside the can to fit the article in place. The duration of the pre-test canning is chosen based on the subsequent test being conducted.

Post-Test Cleanout. After a test is conducted, the following steps are completed to achieve post-test cleanout of the article. The article, mat and can assembly are placed in an oven at 650° C. and held at 650° C. for a duration, usually about 6 hours so that the soot that was loaded into the article is burned out of the article.

### Clean Filtration Efficiency

As used herein, the “clean filtration efficiency” of a honeycomb body or filtration article refers to a new or regenerated honeycomb body that does not comprise any measurable soot loading. In embodiments, the clean filtration efficiency of the honeycomb body or filtration article is greater than or equal to 70%, such as greater than or equal to 80%, or greater than or equal to 85%. In yet other embodiments, the initial filtration efficiency of the honeycomb body or filtration article is greater than 90%, such as greater than or equal to 93%, or greater than or equal to 95%, or greater than or equal to 98%.

As used herein, “Clean Filtration Efficiency Test” refers to testing an article as follows.

After pre-test canning for 6 hours, an air stream is supplied by a blower upstream of the article at a ramped rate, and clean pressure drop is measured across the filter using a differential pressure sensor/gauge at room temperature (about 25° C.). The flow rate of the air stream was ramped from 25.5 m³/h to 356.8 m³/h over 10 step increases, where the flow rate was maintained for one minute at each new step increase. Each step increase was in a range of about 8 to 68 m³/h. Next, an air stream containing soot particles at a concentration of 8 mg/m³ and a flow rate of 22.5 m³/h is introduced upstream of the filter for 45 minutes. The soot is generated at ˜110 nm particle size from a commercially-available propane burner. Clean filtration efficiency at 30° C. is determined by measuring the difference between a number of particulates that are introduced into the article and a number of particulates that exit the article before and after exposure to the flow conditions. After the clean filtration efficiency is measured, post-test cleanout is conducted for 6 hours.

### Soot Loaded Pressure Drop Test

After pre-test canning for 6 hours, soot is loaded into the article with a flow rate of an exhaust gas upstream from the assembly ramped from 25.5 m³/h to 356.8 m³/h over 10 step increases at about 25° C., where the flow rate was maintained for one minute at each new step increase. Each step increase was in a range of about 8-68 m³/h. Soot loading was increased from 0 g/L to 3 g/L. A soot loaded pressure drop is measured across the filter using a differential pressure sensor/gauge at room temperature (about 25° C.) after the filter is loaded with soot. After the soot loaded pressure drop was measured, post-test cleanout is conducted for 6 hours.

### Examples 1-2 and Example A

Agglomerate sizes for utilization of different liquid vehicles were measured. Table 3 lists the different liquid vehicles tested and the corresponding particle dispersant and the resulting agglomerate size.

TABLE 3
Organic-based suspensions

| | Liquid | | Volume-based |
|---|---|---|---|
| Sample No. | vehicle | Particle dispersant | D50 |
| Example A | Ethanol | Triethanolamine | 0.96 μm |
| (comparative) | | | |
| Example 1 | Methanol | Triethanolamine | 0.82 μm |
| Example 2 | Acetone | Vinyltrimethoxysilane | 0.69 μm |

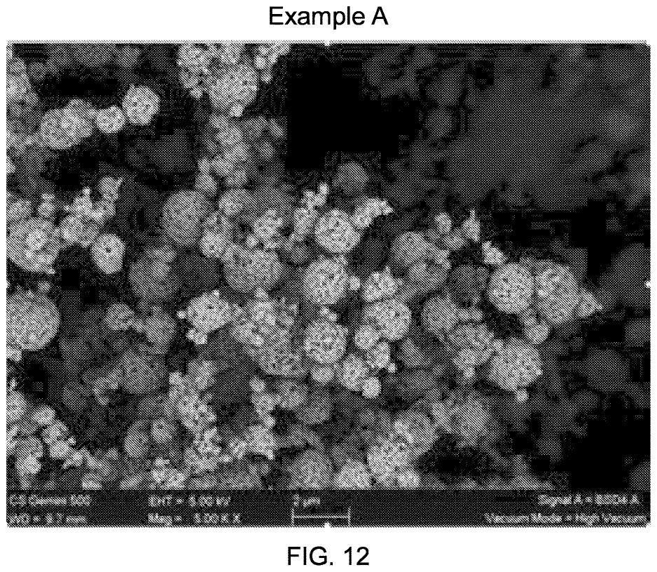

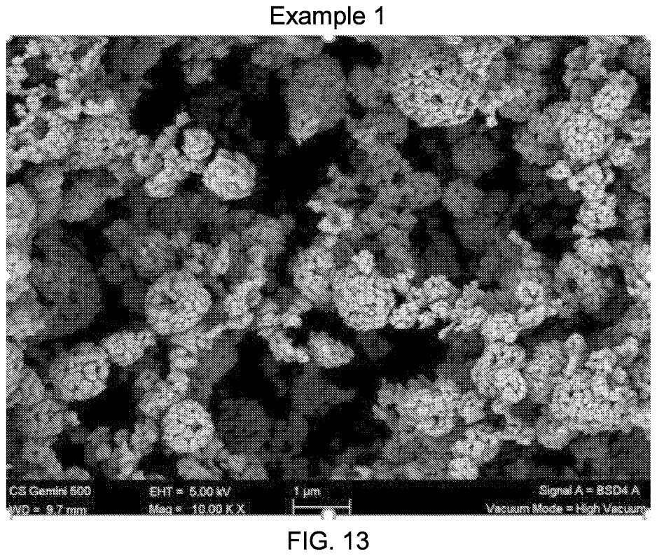

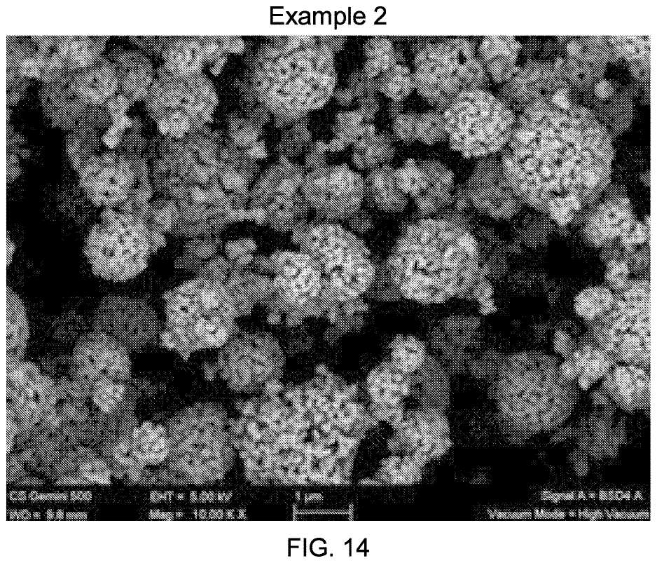

FIGS. 12-14 provide SEM photographs showing samples prepared according to Example A and Examples 1-2. The average agglomerate sizes were measured, and the volume based D50 for agglomerates from the ethanol case, methanol case, and acetone case were 0.96 μm, 0.82 μm, and 0.69 μm, respectively. Basic microstructure of the agglomerates was similar amongst different solvents, but the sizes were different.

Table 4 provides filtration efficiency (FE) by filtration performance at 0.3 μm versus loading (g/L) for Example A and Examples 1-2. As a result of the smaller agglomerate sizes, filtration articles prepared with the methanol-based and acetone-based suspensions have higher FEs at the same loading (in another word, lower loading for the same FE) than the filters prepared with ethanol-based suspension (baseline or reference). The suspension stabilities for the three suspensions were all reasonably good after 24 hours of standing. This indicates that: (1) the dispersants that were selected for different solvents performed well; (2) the loading-FE relationship difference among different solvents shown in Table 4 is not due to the suspension stability, instead, majorly, due to the difference in the solvent properties.

TABLE 4
Filtration Efficiency

| Sample No. | Liquid vehicle | Loading (g/L) | FE at 0.3 μm (%) |
|---|---|---|---|
| Example A | Ethanol | 1.95 | 87.5 |
| (comparative) | | 3.08 | 94.4 |
| | | 4.82 | 98.8 |
| | | 4.84 | 98.6 |
| Example 1 | Methanol | 2.34 | 92.5 |
| | | 2.52 | 95.6 |
| | | 2.69 | 97.3 |
| | | 4.96 | 99.4 |
| | | 5.13 | 99.6 |
| Example 2 | Acetone | 2.37 | 95.2 |
| | | 2.92 | 96.8 |
| | | 5.17 | 99.0 |

### Example 3 and Example B

Agglomerate sizes for utilization of different liquid vehicles were measured. Table 5 lists the different liquid vehicles tested and the corresponding particle dispersant and the resulting agglomerate size.

TABLE 5
Water-based suspensions

| | | | Volume-Average |
|---|---|---|---|
| Sample No. | Liquid vehicle | Particle dispersant | Particle Diameter |
| Example B | Water (only) | Acetic Acid | 1.56 μm |
| (comparative) | | | |
| Example 3 | 50% water and | Acetic Acid | 0.97 μm |
| | 50% ethanol | | |

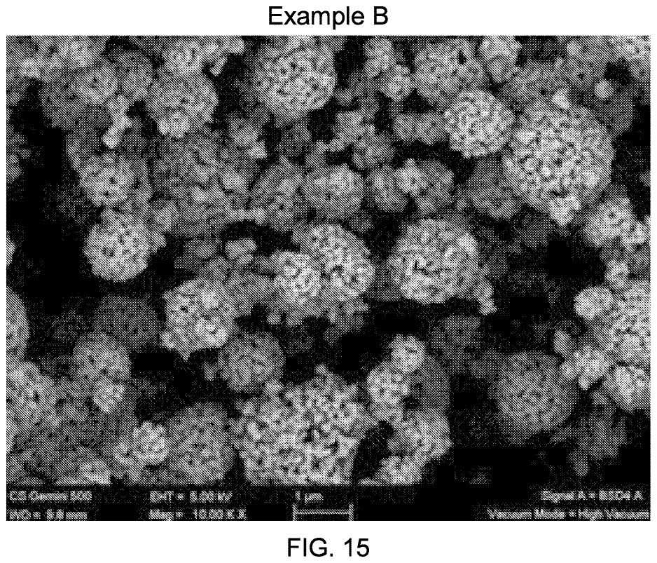

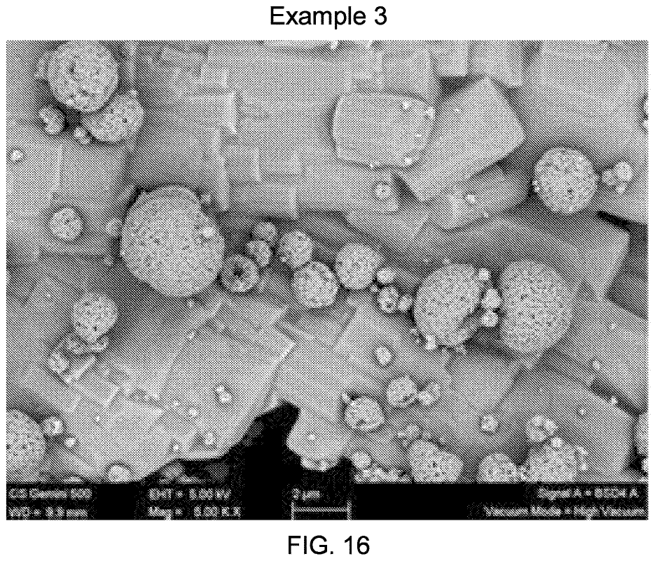

FIGS. 15-16 provide SEM photographs showing samples prepared according to Example B and Example 3. The particles from 50% water/50% ethanol case has an average particle diameter of 0.97 μm, which is smaller than the particle diameter made with pure water suspension (1.56 μm).

Table 6 provides filtration efficiency (FE) by filtration performance at 0.3 μm versus loading (g/L) for Example B and Example 3. As a result of the smaller agglomerate sizes, filtration articles prepared with the 50% water/50% ethanol suspension had a higher FE than the filter made with pure water suspension. The suspension stabilities for the three suspensions were all reasonably good after 24 hours of standing. No sign of sedimentation was observed via visual inspection.

TABLE 6
Filtration Efficiency

| Sample No. | Liquid vehicle | Loading (g/L) | FE at 0.3 μm (%) |
|---|---|---|---|
| Example B | Water (only) | 2.78 | 73.7 |
| (comparative) | | | |
| | | 2.86 | 83.4 |
| | | 5.00 | 93.1 |
| Example 3 | 50% water and | 2.51 | 79.7 |
| | 50% ethanol | | |
| | | 2.54 | 93.9 |
| | | 5.15 | 99.0 |

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A method for applying a surface treatment to a plugged honeycomb body comprising a honeycomb structure of a plurality of axial porous walls defining a plurality of axial channels extending in an axial direction, the method comprising:
atomizing a dispersion of particles of an inorganic material into liquid-particulate-dispersant droplets comprised of:
a liquid vehicle comprising methanol, acetone, hexane, or combinations thereof;
a particle dispersant comprising: triethanolamine, triethoxyvinylsilane, vinyltrimethoxysilane, 5-hexanyltrimethoxysaline, or combinations thereof; and
the particles;
evaporating substantially all of at least the liquid vehicle from the droplets to form agglomerates of the particles;
depositing the agglomerates within the plugged honeycomb body; and
wherein the deposited agglomerates are disposed on, or in, or both on and in, the porous walls.

2. The method of claim 1, further comprising atomizing a binder with the dispersion such that the droplets are liquid-particulate-dispersant-binder droplets and the agglomerates further comprise the binder.

3. The method of claim 1, wherein when the liquid vehicle comprises the methanol, the particle dispersant comprises the triethanolamine; or when the liquid vehicle comprises the acetone, the particle dispersant comprises the triethoxyvinylsilane or the vinyltrimethoxysilane; or when the liquid vehicle comprises the hexane, the particle dispersant comprises the 5-hexanyltrimethoxysaline.

4. The method of claim 1, wherein the atomizing further comprises supplying a suspension of the particles, the liquid vehicle, and the particle dispersant.

5. The method of claim 1, wherein the particles are mixed with the liquid vehicle and the particle dispersant to form a liquid-particulate-dispersant stream, and the liquid-particulate-dispersant stream is directed into an atomizing nozzle.

6. The method of claim 5, wherein the liquid-particulate-dispersant stream mixes with an atomizing gas via the atomizing nozzle.

7. The method of claim 1, wherein the droplets are aerosolized and conveyed toward the plugged honeycomb body by a gaseous carrier stream.

8. The method of claim 1, wherein the depositing of the agglomerates within the plugged honeycomb body comprises filtering the agglomerates from the gaseous carrier stream with the porous walls of the plugged honeycomb body.

9. The method of claim 7, wherein the carrier gas comprises essentially no liquid vehicle upon entry to a chamber of the duct.

10. The method of claim 14, wherein the agglomerates comprise a volume-based average particle diameter (D₅₀) for a given set of operating conditions that is smaller than a comparative volume-based average particle diameter (D₅₀) of comparative agglomerates formed by a method using the given set of operating conditions except for use of ethanol as the liquid vehicle.

11. A method for applying a surface treatment to a plugged honeycomb body comprising a honeycomb structure of a plurality of axial porous walls defining a plurality of axial channels extending in an axial direction, the method comprising:
atomizing a dispersion of particles of an inorganic material into liquid-particulate-dispersant-binder droplets consisting essentially of: a liquid vehicle comprising methanol, acetone, hexane, or combinations thereof, a particle dispersant, a binder, and the particles;
evaporating substantially all of at least the liquid vehicle from the droplets to form agglomerates of the particles;
depositing the agglomerates within the plugged honeycomb body; and
wherein the deposited agglomerates are disposed on, or in, or both on and in, the porous walls.

12. The method of claim 11, wherein the particle dispersant comprises: triethanolamine, triethoxyvinylsilane, vinyltrimethoxysilane, 5-hexanyltrimethoxysaline, or combinations thereof.

13. The method of claim 11, wherein the atomizing further comprises supplying a suspension of the particles, the liquid vehicle, the binder, and the particle dispersant.

14. The method of claim 1, wherein the particles are mixed with the liquid vehicle, the particle dispersant, and the binder to form a liquid-particulate-dispersant-binder stream, and the liquid-particulate-dispersant-binder stream is directed into an atomizing nozzle.

15. The method of claim 14, wherein the liquid-particulate-dispersant-binder stream mixes with an atomizing gas via the atomizing nozzle.

16. The method of claim 11, wherein the droplets are aerosolized and conveyed toward the plugged honeycomb body by a gaseous carrier stream.

17. The method of claim 16, wherein the depositing of the agglomerates within the plugged honeycomb body comprises filtering the agglomerates from the gaseous carrier stream with the porous walls of the plugged honeycomb body.

18. The method of claim 16, wherein the carrier gas comprises essentially no liquid vehicle upon entry to a chamber of the duct.

19. The method of claim 11, wherein the agglomerates comprise a volume-based average particle diameter (D₅₀) for a given set of operating conditions that is smaller than a comparative volume-based average particle diameter (D₅₀) of comparative agglomerates formed by a method using the given set of operating conditions except for use of ethanol only as the liquid vehicle.

20. The method of claim 1, wherein at least some of the agglomerates adhere to the porous walls.

21. A filtration article prepared according to the method of claim 1, the filtration article comprising a filtration efficiency greater than or equal to 95.0% and a loading of the deposited agglomerates less than or equal to 6 grams of the deposited agglomerates per liter of the honeycomb filter body.

22. The filtration article of claim 21, wherein the filtration efficiency is greater than or equal to 99.0%.

23. The filtration article of claim 21, wherein the loading of the deposited agglomerates is greater than or equal to 2 grams of the deposited agglomerates per liter of the honeycomb filter body.

24. The filtration article of claim 23, wherein the loading of the deposited agglomerates is less than or equal to 3 grams of the deposited agglomerates per liter of the honeycomb filter body.

25.-40. (canceled)
